(19) United States
(12) Patent Application Publication
(10) Pub. No.: US 2025/0252139 A1
(43) Pub. Date: Aug. 7, 2025

(54) ARTIFICIAL INTELLIGENCE DRIVEN DOMAIN-SPECIFIC VALIDATION SYSTEM

(71) Applicant: Wells Fargo Bank, N.A., San Francisco, CA (US)

(72) Inventors: Rahul Singh, Charlotte, NC (US); Dipanjan Deb, Bangalore (IN); Karan Jeswani, Mumbai (IN); Ridhi Puppala, Hyderabad (IN); Mohammad Ahmadi Achachlouei, San Francisco, CA (US); Anand Iyer, Bangalore (IN); Adarsh Behre, Raipur (IN)

(21) Appl. No.: 19/046,121

(22) Filed: Feb. 5, 2025

Related U.S. Application Data
(60) Provisional application No. 63/550,402, filed on Feb. 6, 2024.

(51) Int. Cl. G06F 16/93

(52) U.S. Cl. CPC G06F 16/93

(57) ABSTRACT

Systems, apparatuses, methods, and computer program products are disclosed for efficiently handling queries. An example method includes receiving a query from a user device and generating an embedding representation of the query. The example method further includes performing a similarity comparison between the embedding representation of the query and a set of embedding representations of historical document sections stored in a historical document repository and selecting a relevant embedding representation of a historical document section stored in the historical document repository for the query. The example method further includes querying a target large language model using the embedding representation of the query and the relevant embedding representation of the historical document section and providing a query response to the user device.

### CROSS REFERENCE TO RELATED APPLICATIONS

The present application claims the benefit of U.S. Provisional Application No. 63/550,402, filed Feb. 6, 2024, which is hereby incorporated by reference in its entirety.

### BACKGROUND

Institutions often have various guidelines and rules that they must comply with for purposes such as quality assurance, legal compliance, and security protocol compliance. Each institution may rely on specific metrics or criteria to validate whether documents, media, data, or other outputs adhere to these guidelines. These rules can vary significantly across institutions and even across different groups within the same institution, adding complexity to the validation process.

### BRIEF SUMMARY

As described above, institutions adhere to various rules, some of which are specific to the particular institution. This requires various entities within the institution to validate internal and/or external output, such as documents, communications, media, data, or the like, to ensure the output complies with the rules of the institution. Ensuring this compliance is crucial to ensure that the content of the output aligns with the internal institution rules/policies, legal standards, ethical standards, or the like. Output that does not adhere to these various rules may face ramifications, such as legal penalties, reputational risks, and the like.

However, traditional output validation processes have been labor, time, and resource intensive. Conventionally, these validation processes require manual review of the output, such as from managers, supervisors, quality control agents, etc. In addition to being resource intensive, manual review of output is also prone to errors because different reviewers may apply varying levels of scrutiny.

Additionally, documentation such as model development documents (MDDs) and model validation documents (MVDs), which outline methodologies and evaluations for model development and validation, are often dense and complex. This complexity makes it difficult for users to navigate the documents and extract relevant information. Furthermore, creating MDDs and MVDs manually increases the likelihood of errors, which is particularly problematic as the documents need to be aligned and consistent to ensure traceability and compliance across a model's lifecycle.

In contrast to these conventional techniques for validation tasks, example embodiments described herein use a validation system that allows for automatic, dynamic validation of various outputs for an institution. In particular, the validation system may use one or more large language models (LLMs) to automatically perform various validation operations. The LLMs may be trained for one or more validation applications, including an internal chat application, a document compliance check application, a document chat application, a data summary application, a document summary application, a document change detection application, a new document generation application, a query application, and/or the like.

Furthermore, the LLMs may be trained to evaluate input in accordance with the particular institution rules and standards. Thus, the LLMs may perform these validation operations in a manner that is tailored to the specific needs of the institution. In particular, the LLMs may be trained using a training routine. The training routine may initialize a base LLM to start and use transfer learning to fine-tune an LLM. By leveraging transfer learning, the training process required to train the LLM may be shortened and result in a more effective and accurate model. The LLM may then be fine-tuned using a domain-specific training data set. This domain-specific training data set may be curated to include domain-specific documents, domain-specific media, and/or domain-specific data such that the LLM may be fine-tuned to capture the institutions requirements.

Example embodiments also allow authorized users to intelligently store and manage historical documents, such as MDDs and/or MVDs, in an associated historical document repository. In particular, a received historical document may be partitioned into one or more historical document sections, which ensures the section's context is preserved for processing by the LLM, which may have token size limitations. A document embedding routine is performed on the historical document sections, wherein the content of a historical document is tokenized into a plurality of historical document section tokens and transformed into an embedding representation of the historical document section by converting the plurality of historical document section tokens into a plurality of historical document section embeddings. By doing so, a historical document is transformed from high-dimensional data into lower-dimensional vector representations, thereby reducing the storage requirements while still preserving the content's semantic meaning. These compact embedding representations that include historical document section embeddings are then stored in an associated historical document repository, thereby reducing storage requirements while enabling efficiency real-time content retrieval through similarity-based searching techniques.

Example embodiments further provide a real-time query responses to queries received from a user. A user may submit a query related to content within historical documents. Example embodiments may generate a query response by tokenizing the query into a plurality of query tokens, generate an embedding representation of the query, and comparing the embedding representation of query embeddings with a set of embedding representations of historical document sections. Example embodiments may select a relevant document section embedding and query the LLM using the embedding representation of the query and the relevant document section embedding to generate a query response. The query response may include a direct response to the query as well as links to the corresponding relevant historical document sections. This ensures users receive accurate, contextually relevant answers in real-time. Furthermore, example embodiments only provide the LLM with relevant embeddings, thereby reducing the computational overhead while still ensuring an accurate query response.

To provide the query response, example embodiments described herein may tokenize the query into a plurality of query tokens and generate an embedding representation of the query. Example embodiments perform a similarity comparison to determine a similarity between the embedding representation of the query and a set of embedding representations of historical document sections. A relevant historical document section embedding may be selected based on the similarity comparison and the relevant historical document section embedding may be retrieved from a historical document repository. Example embodiments may then query the LLM using the embedding representation of the query and the relevant document section embedding. In some embodiments, the query response includes a generated answer that is responsive to the question posed in the query. The query response may further include links to sources of the relevant historical document sections. In this way, a user is provided with a tailored answer to their query along with the sources of information identified as relevant for the query in real-time.

In some embodiments, a query received from a user may request that an input document be evaluated. By way of particular example, the input document may be a draft MDD or draft MVD. The user may wish to ensure the current input document complies with various policies, standards, regulations, etc. and flag any potential compliance or consistency issues in real-time. Here, example embodiments may query the LLM using the embedding representation for each target document section and the relevant document section embedding. In some embodiments, the LLM may generate and output an evaluation assessment. The evaluation assessment may include an evaluation status for each target document section. In some embodiments, an evaluation status may be indicative of whether a target document section is fully compliant, partially compliant, or non-compliant. If a target document section is partially compliant or non-compliant, the LLM may provide the reasons for an issue, such as identifying missing details or information, incorrect data, and/or the like. The LLM may further provide a recommendation to address the compliance issue and bring the target document section to full-compliance. The compliance status, identified compliance issues, and recommendations may be included in the query response. In this way, user may proactively address compliance issues in real-time. Users may further be presented with suggestions on how to address the compliance issues along with the relevant historical document sections, thus saving valuable time.

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used to perform various validation tasks using a large language model.

FIG. 2 illustrates a schematic block diagram of example circuitry embodying a system device that may perform various operations in accordance with some example embodiments described herein.

FIG. 3 illustrates an example flowchart for generating a compliance checklist in accordance with a document compliance check application, in accordance with some example embodiments described herein.

FIG. 4 illustrates an example flowchart for generating a response to a query prompt and reason for the response, in accordance with some example embodiments described herein.

FIG. 5 illustrates an example flowchart for generating a domain-specific response in accordance with an internal chat application, in accordance with some example embodiments described herein.

FIG. 6 illustrates an example flowchart for adjusting an internal state of a large language model, in accordance with some example embodiments described herein.

FIG. 7 illustrates an example flowchart for generating a domain-specific response based on updated main query embeddings, in accordance with some example embodiments described herein.

FIG. 8 illustrates an example flowchart for generating a query response in accordance with a document chat application, in accordance with some example embodiments described herein.

FIG. 9 illustrates an example flowchart for generating a query response in accordance with a data summary application, in accordance with some example embodiments described herein.

FIG. 10 illustrates an example flowchart for generating a summary of an input document in accordance with a document summary application, in accordance with some example embodiments described herein.

FIG. 11 illustrates an example flowchart for generating a document change summary based on an original document and a modified document in accordance with a document change detection application, in accordance with some example embodiments described herein.

FIG. 12 illustrates an example flowchart for generating a contextual difference between a first document section and a second document section, in accordance with some example embodiments described herein.

FIG. 13 illustrates an example flowchart for generating a structured document in accordance with a new document generation application, in accordance with some example embodiments described herein.

FIG. 14 illustrates an example flowchart for fine-tuning a large language model using a training routine, in accordance with some example embodiments described herein.

FIG. 15 illustrates an example flowchart for generating a domain-specific training data set, in accordance with some example embodiments described herein.

FIG. 16 illustrates an example application selection user interface used in some example embodiments described herein.

FIG. 17 illustrates an example input user interface for a document compliance check application used in some example embodiments described herein.

FIG. 18 illustrates an example compliance checklist as used in some example embodiments described herein.

FIG. 19 illustrates an example feedback mechanism user interface for a document compliance check application used in some example embodiments described herein.

FIG. 20 illustrates an example input user interface for an internal chat application used in some example embodiments described herein.

FIG. 21 illustrates an example output user interface for an internal chat application used in some example embodiments described herein.

FIG. 22 illustrates an example query context user interface for an internal chat application used in some example embodiments described herein.

FIG. 23 illustrates an example flowchart for storing a received historical document, in accordance with some example embodiments described herein.

FIG. 24 illustrates an example flowchart for partitioning a historical document section based on the modality type of content, in accordance with some example embodiments described herein.

FIG. 25 illustrates an example flowchart for generating an embedding representation of a historical document section, in accordance with some example embodiments described herein.

FIG. 26 illustrates an example flowchart for tokenizing a historical document section, in accordance with some example embodiments described herein.

FIG. 27 illustrates an example flowchart for handling a received query, in accordance with some example embodiments described herein.

FIG. 28 illustrates an example flowchart for handling a query that requests evaluation of an input document, in accordance with some example embodiments described herein.

FIG. 29 illustrates an example flowchart for tokenizing a target document section, in accordance with some example embodiments described herein.

FIG. 30 illustrates an example query user interface for user to provide a query as used in some example embodiments described herein.

FIG. 31 illustrates an example query user interface for accessing a query response as used in some example embodiments described herein.

FIG. 32 illustrates an example query user interface for accessing a query response that includes an evaluation assessment as used in some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

### System Architecture

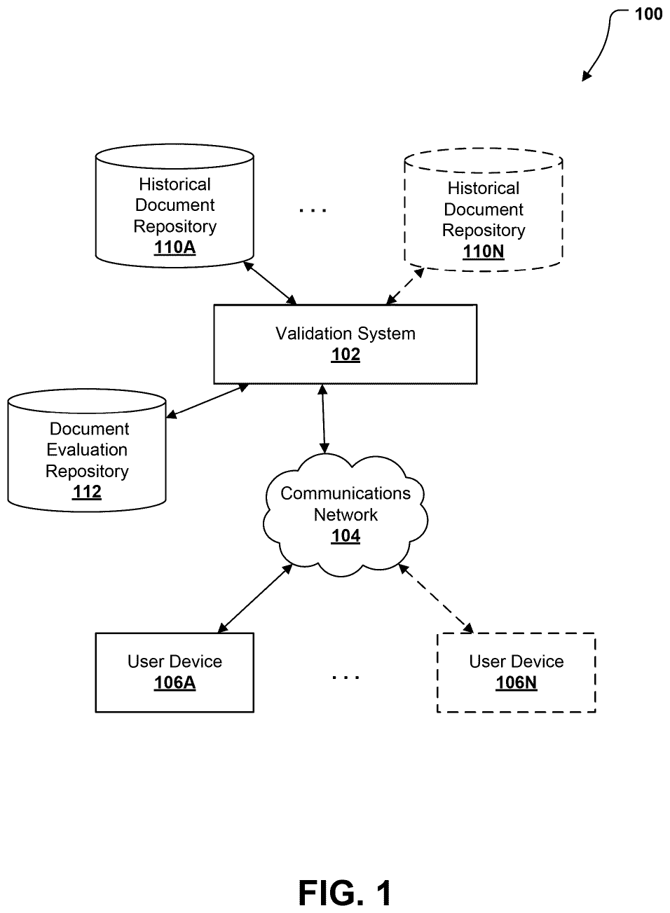

Example embodiments described herein may be implemented using any of a variety of computing devices or servers. To this end, FIG. 1 illustrates an example environment 100 within which various embodiments may operate. As illustrated, a validation system 102 may receive and/or transmit information via communications network 104 (e.g., the Internet) with any number of other devices, such as one or more of user devices 106A-106N, one or more of historical document repositories 110A-110N, and/or a document evaluation repository 112.

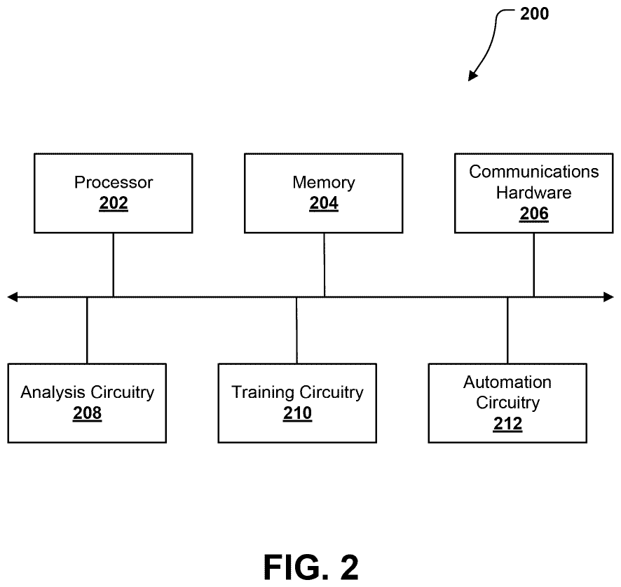

The validation system 102 may be implemented as one or more computing devices or servers, which may be composed of a series of components. Particular components of the validation system 102 are described in greater detail below with reference to apparatus 200 in connection with FIG. 2.

In some embodiments, the validation system 102 further includes one or more historical document repositories 110A-110N. The one or more historical document repositories 110A-110N may comprise distinct components from other components of the validation system 102. The historical document repositories 110A-110N may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The historical document repositories 110A-110N may host the software executed to operate the validation system 102. The historical document repositories 110A-110N may store information relied upon during operation of the validation system 102, such as historical documents, historical document section embeddings, and/or the like. In some embodiments, a given historical document repository may store different historical documentation types. For example, document evaluation repository 110A may store historical documents and/or historical document section embeddings that correspond to MVDs and document evaluation repository 110N may store historical documents and/or historical document section embeddings that corresponds to MDDs.

In some embodiments, the validation system 102 further includes a document evaluation repository 112. The document evaluation repository 112 may comprise distinct components from other components of the validation system 102. The document evaluation repository 112 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 104). The document evaluation repository 112 may host the software executed to operate the validation system 102. The document evaluation repository 112 may store information relied upon during operation of the validation system 102, such as input documents, compliance checklists, evaluation assessments, and/or the like.

In some embodiments, the document evaluation repository 112 is a relational database. In some embodiments, the document evaluation repository 112 may store a file path or URL pointing to where an input document, compliance checklist, evaluation assessment, and/or the like is stored. Alternatively, the document evaluation repository 112 may directly store input documents, compliance checklists, and/or evaluation assessments. In some embodiments another database (not shown in FIG. 1) may store a file path or URL linking to the storage location of input documents, compliance checklists, and/or evaluation assessments stored by the compliance document repository.

The one or more user devices 106A-106N may be embodied by any computing devices known in the art. The one or more user devices 106A-106N need not themselves be independent devices but may be peripheral devices communicatively coupled to other computing devices. In some embodiments, the one or more user devices 106A-106N may be associated with users of the validation system 102 (e.g., employee, developers, coders, regulators, analysts, reviewers, or the like).

Although FIG. 1 illustrates an environment and implementation in which the validation system 102 interacts indirectly with a user via one or more of user devices 106A-106N, in some embodiments users may directly interact with the validation system 102 (e.g., via communications hardware of the validation system 102) and/or historical document repositories 110A-110N, in which case a separate user device 106A-106N may not be utilized. Whether by way of direct interaction or indirect interaction via another device, a user may communicate with, operate, control, modify, or otherwise interact with the validation system 102 to perform the various functions and achieve the various benefits described herein.

### Example Implementing Apparatuses

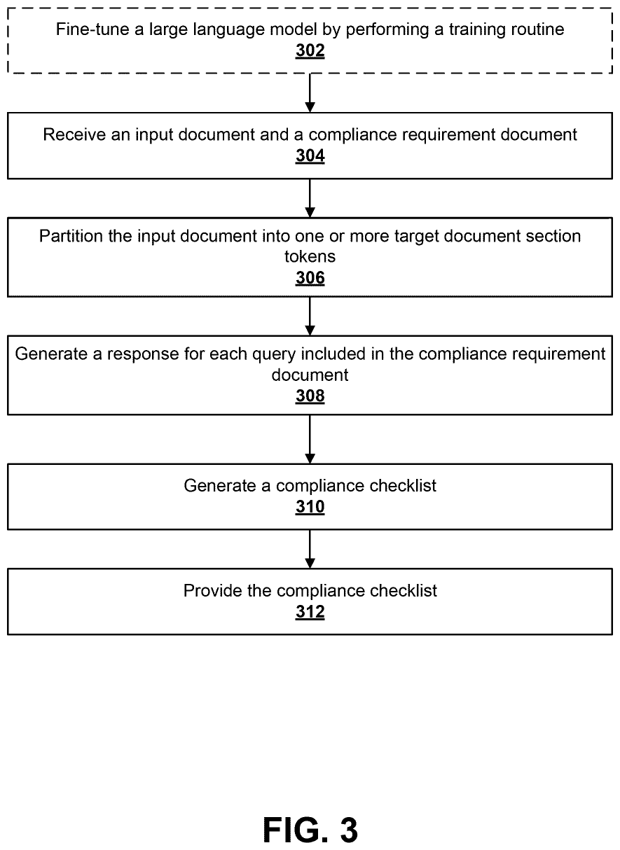

The validation system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-32. As illustrated in FIG. 2, the apparatus 200 may include processor 202, memory 204, communications hardware 206, analysis circuitry 208, training circuitry 210, and automation circuitry 212, each of which will be described in greater detail below.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as a web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In addition, the apparatus 200 further comprises an analysis circuitry 208 that may be configured to tokenize input documents, identify target document sections, generate a response to a query prompt, generate a reason for a response, generate a compliance checklist, and/or the like. In some embodiments, the analysis circuitry 208 may be configured to identify a query context and a main query, adjust an internal state of an LLM, generate a domain-specific response, tokenize a query, and/or the like. In some embodiments, the analysis circuitry 208 may be configured to tokenize an input document into one or more target document sections, generate a response to the query prompt, and/or the like. In some embodiments, the analysis circuitry 208 may be configured to identify one or more data values, generate a summary of the input data, identify one or more target data values, and/or the like. In some embodiments, the analysis circuitry 208 may be configured to tokenize an input document into one or more document sections, determine one or more target document sections from the one or more document sections, and generate a summary of the input document, and/or the like. In some embodiments, the analysis circuitry 208 may be configured to tokenize an original document into one or more original document sections, tokenize a modified document into one or more modified document sections, perform a change detection routine, identify a first document section, identify a second document section, determine a contextual difference between the first document section and the second document section, generate a document summary, and/or the like. In some embodiments, the analysis circuitry 208 may further be configured to tokenize a query, generate a plurality of query embeddings, perform a similarity comparison, identify a plurality of relevant historical document section embeddings, retrieve the relevant historical document section embeddings, and generate a query response. In some embodiments, the analysis circuitry 208 may further be configured to determine whether the query requests evaluation of an input document, partition the input document into one or more target document sections, tokenize the target document sections, generate a plurality of target document section embeddings, and generate an evaluation assessment. In some embodiments, the analysis circuitry 208 may be configured to generate software-executable instructions and/or the like. The analysis circuitry 208 may utilize processor 202, memory 204, or any other hardware component included in the apparatus 200 to perform these operations, as described in connection with FIGS. 3-32 below. The analysis circuitry 208 may further utilize communications hardware 206 to gather data from a variety of sources (e.g., user device 106A-106N, as shown in FIG. 1), and/or exchange data with a user.

In addition, the apparatus 200 further comprises a training circuitry 210 that is configured to perform a training routine, initializing a base LLM, providing a domain-specific training data set to the base LLM, adjusting parameters of the base LLM, fine-tuning the LLM, generating the domain-specific training data set, and/or the like. The training circuitry 210 may utilize processor 202, memory 204, or any other hardware component included in the apparatus 200 to perform these operations, as described in connection with FIGS. 3-32 below. The training circuitry 210 may further utilize communications hardware 206 to gather data from a variety of sources (e.g., user device 106A-106N, as shown in FIG. 1), and/or exchange data with a user.

Further, the apparatus 200 further comprises automation circuitry 212 that is configured to generate a structured document, generate one or more structured document values, and/or the like. In some embodiments, the automation circuitry 212 may further be configured to perform a proactive compliance action. The automation circuitry 212 may utilize processor 202, memory 204, or any other hardware component included in the apparatus 200 to perform these operations, as described in connection with FIGS. 3-32 below. The automation circuitry 212 may further utilize communications hardware 206 to gather data from a variety of sources (e.g., user device 106A-106N, as shown in FIG. 1), and/or exchange data with a user.

Although components 202-212 are described in part using functional language, it will be understood that the particular implementations necessarily include the use of particular hardware. It should also be understood that certain of these components 202-212 may include similar or common hardware. For example, the analysis circuitry 208, training circuitry 210, and automation circuitry 212 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the terms “circuitry” and “engine” with respect to elements of the apparatus therefore shall be interpreted as necessarily including the particular hardware configured to perform the functions associated with the particular element being described. Of course, while the terms “circuitry” and “engine” should be understood broadly to include hardware, in some embodiments, the terms “circuitry” and “engine” may in addition refer to software instructions that configure the hardware components of the apparatus 200 to perform the various functions described herein.

Although the analysis circuitry 208, training circuitry 210, and automation circuitry 212 may leverage processor 202, memory 204, or communications hardware 206 as described above, it will be understood that any of analysis circuitry 208, training circuitry 210, and automation circuitry 212 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that analysis circuitry 208, training circuitry 210, and automation circuitry 212 comprise particular machinery designed for performing the functions described herein in connection with such elements of apparatus 200.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of graphical user interfaces and flowcharts.

### Example Operations

Turning to FIGS. 3-15 and FIGS. 23-29, example flowcharts are illustrated that contain example operations implemented by example embodiments described herein. The operations illustrated in FIGS. 3-15 and 23-29 may, for example, be performed by a system device of the validation system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, analysis circuitry 208, training circuitry 210, automation circuitry 212, and/or any combination thereof. It will be understood that user interaction with the validation system 102 may occur directly via communications hardware 206, or may instead be facilitated by a separate user device (e.g., any one of user devices 106A-106N), as shown in FIG. 1, and which may have similar or equivalent physical componentry facilitating such user interaction.

### Example Operations for a Document Compliance Check Application

Turning first to FIG. 3, example operations are shown for generating a compliance checklist. In particular, a compliance checklist may be generated for an input document in view of a compliance requirement document. Advantageously, embodiments described herein provide for automated evaluation of a given input document. This eliminates the need for intensive manual review and further, ensures faster and more reliable compliance results. Example embodiments intelligently partition an input document into target sections, thereby maintaining contextual integrity of the content during subsequent processing by an LLM. In doing so, example embodiments effectively overcome the LLMs maximum token limit, thereby ensuring that even lengthy input documents can be processed without sacrificing context or accuracy. Furthermore, example embodiments leverage knowledge of input document structure to initially identify only a target document section that corresponds to a given query within a compliance requirement document. Only this target document section is tokenized, thus reducing unnecessary computational overhead and minimizing potential errors that could arise from processing the entire input document or irrelevant sections.

Example embodiments described herein also allow for real-time or near-real time generation of compliance checklists. This provides immediate feedback to users, enabling them to quickly identify and address gaps in compliance. This is particularly important when time-sensitive decisions, such as submitting regulatory filings, are required. Additionally, the real-time generation of compliance checklists can improve the operational efficiency of systems by reducing delays and/or eliminating bottlenecks in processes dependent upon these compliance checks. Furthermore, real-time compliance ensures that issues are identified and addressed before they escalate. This prevents costly penalties and conserves manual and computational resources that would otherwise need to be expended to retroactively address the issues.

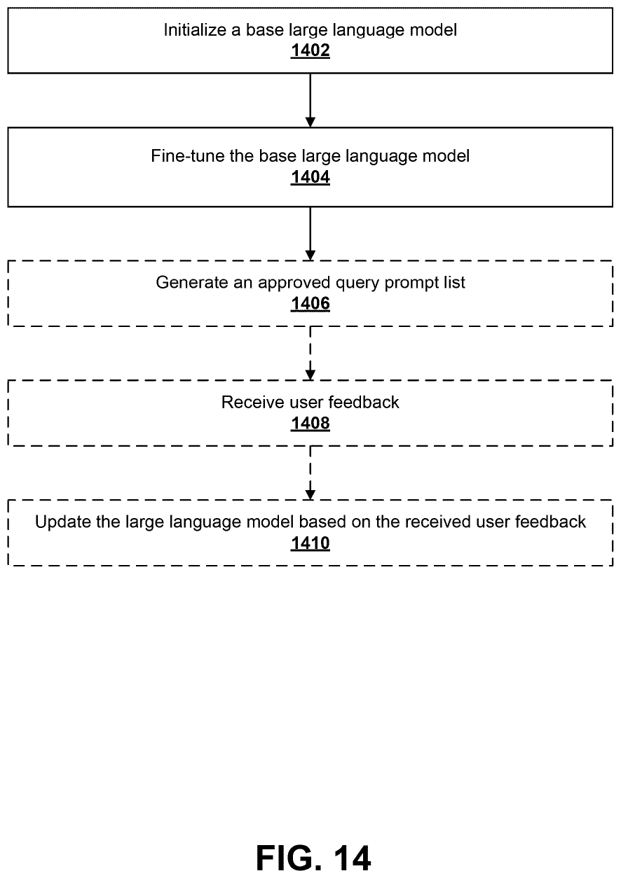

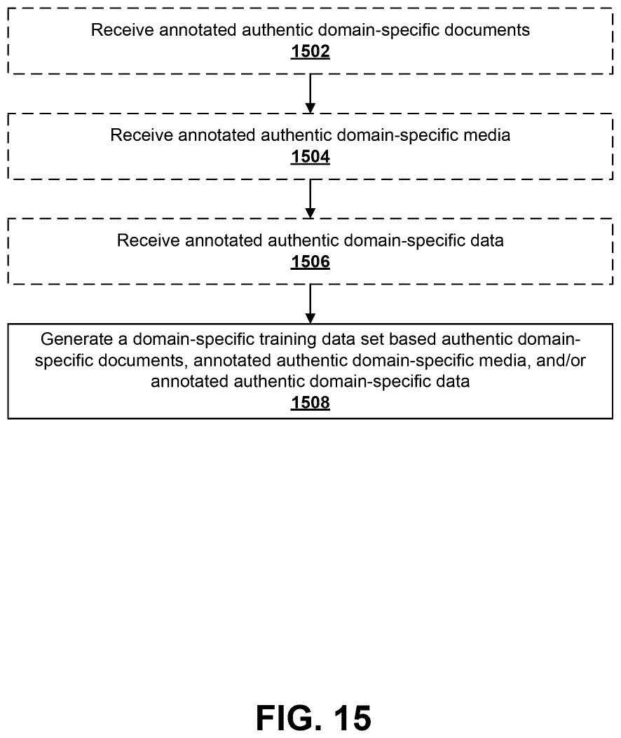

Optionally, as shown by operation 302, the apparatus 200 includes means, such as training circuitry 210 or the like for fine-tuning a LLM by performing a training routine. In some embodiments, the training circuitry 210 may perform the training routine in accordance with the operations described in FIGS. 14-15, as described in greater detail below.

As shown by operation 304, the apparatus 200 includes means, such as communications hardware 206 or the like for receiving an input document and a compliance requirement document. An input document may be a document a user may provide and desire to be evaluated to ensure compliance. The input document may be a document formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), and/or the like.

The compliance requirement document may be a document that includes one or more queries that can be used to validate the input document. Each query of the compliance requirement document may include a query prompt. The compliance requirement document may be a document formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), and/or the like.

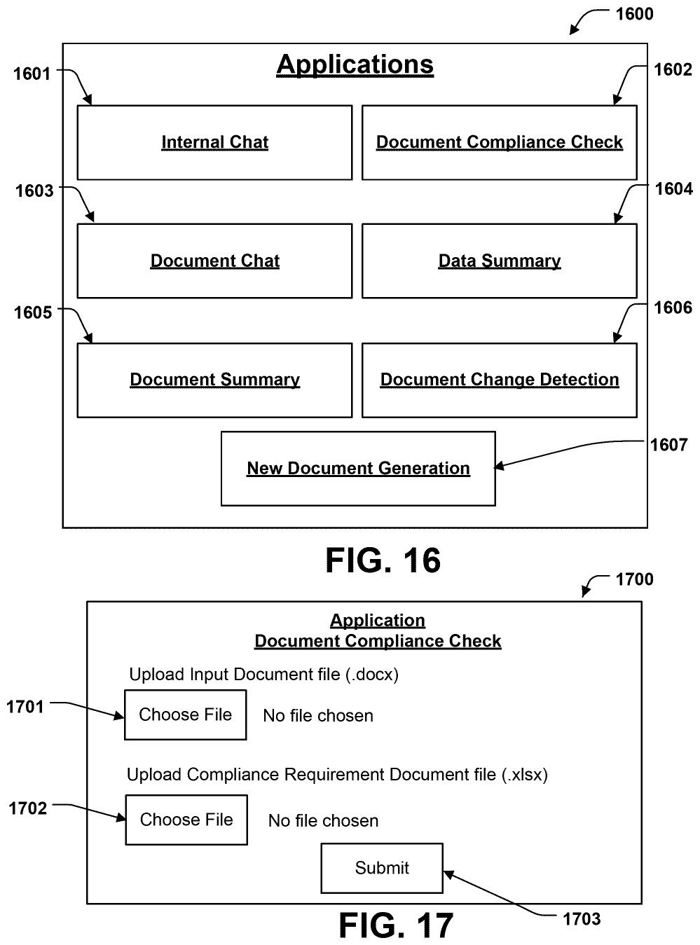

The communications hardware 206 may receive the input document and the compliance requirement document from a user, such as via a user device (e.g., any one or user devices 106A-106N). In some embodiments, a user may use the user device to interact with an application selection interface and select a document compliance check application as illustrated in FIG. 16, which is described in further detail below. The user may use an input user interface 1700 of the document compliance check application to provide the input document and compliance requirement document as illustrated in FIG. 17. FIGS. 16 and 17 are described in further detail below.

As shown by operation 306, the apparatus 200 includes means, such as analysis circuitry 208 or the like for partitioning the input document into one or more target document sections. In some embodiments, the analysis circuitry 208 may be used to partition the input document into one or more target document sections. In some embodiments, the analysis circuitry 208 may use the compliance requirement document to determine the one or more target document sections. As described above, the compliance requirement document may include one or more queries. A query of the compliance requirement document may be associated with a query number, a target document section, and a query prompt. Thus, the analysis circuitry 208 may process the compliance requirement document to determine the target document sections relevant for the input document.

In some embodiments, the analysis circuitry 208 may use a pre-processing model to pre-process the input document to remove or replace particular characters (e.g., special characters), remove certain formatting (e.g., convert all characters to lowercase or uppercase), and/or the like. The analysis circuitry 208 may be configured to identify a target document section based on a particular text sequence that is used to demarcate the beginning of a target document section. For example, the analysis circuitry 208 may be configured to identify the start of a first target document section by identifying the text sequence “Executive Summary”. The analysis circuitry 208 may be configured to identify the end of the first target document section by identifying a next text sequence “Overview”. The content between the text sequence “Executive Summary” and “Overview” and in some embodiments, the first text sequence “Executive Summary”, may be identified as the first target document section. In some embodiments, the analysis circuitry 208 may further be configured to identify the target document section by analysing the formatting of a text sequence. For example, the analysis circuitry 208 may be configured to identify the text sequence that is capitalized, underlined, formatted in a particular style (e.g., a “title” style in a word processing formatted document), a lack of additional characters until a next line (e.g., only the text sequence on a particular line), and/or the like.

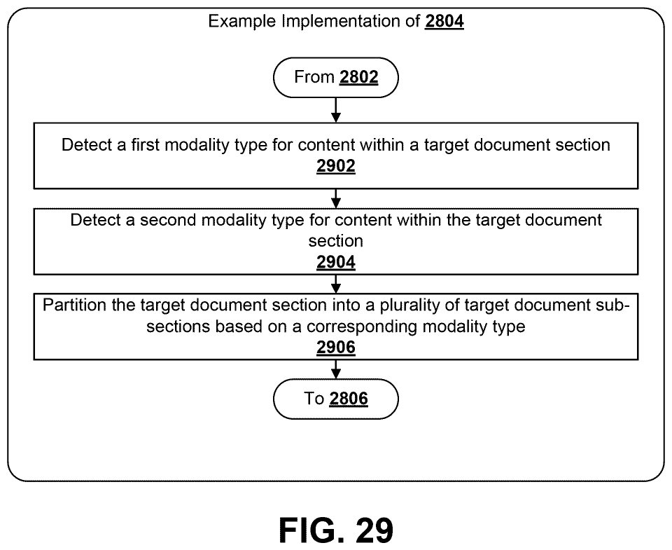

In some embodiments, operations 306 may be performed in accordance with the operations described by FIG. 29, which is described in further detail below. In some embodiments, the input document may be partitioned based on a modality type of content within a given input document section.

As shown by operation 308, the apparatus 200 includes means, such as communications hardware 206, analysis circuitry 208, or the like, for generating a response for each query included in the compliance requirement document. The analysis circuitry 208 may use an LLM to generate a response to each query included in the compliance document. In some embodiments, the response to the query includes a binary response to the query prompt and a reason for the response. In some embodiments, the LLM may be used to process queries from the compliance requirement document in sequential order. The analysis circuitry 208 may use the query to identify a target document section to which the query prompt pertains. The analysis circuitry 208 may then use the LLM to process the query prompt and the target document section to generate the response. The LLM may output the response to each query to the analysis circuitry 208. In some embodiments, the analysis circuitry 208 may receive the response to each query using communications hardware 206.

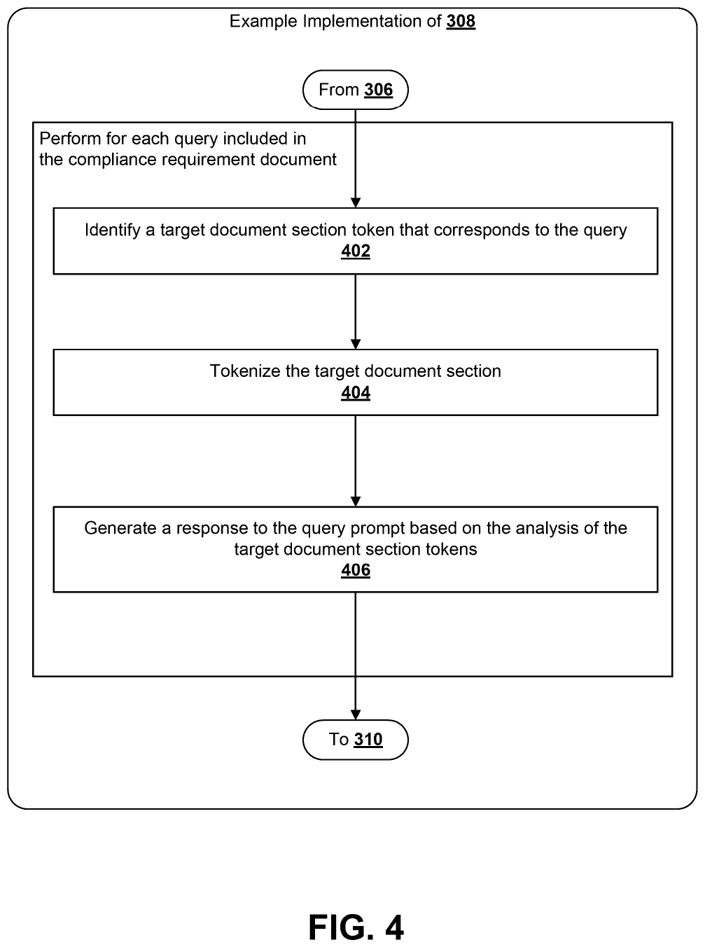

The response to the query may be indicative of whether a particular condition, status, or other criteria described by the query prompt is satisfied by the target document section. For example, the query prompt may be a prompt as to whether the document text for the ‘Executive Summary” target document section addresses the weaknesses found in a validation process by addressing relevant findings. The response to the query prompt may be “yes” in an instance in which the LLM determines the target document section satisfies this query prompt, or “no” in an instance in which the LLM determines the target document section fails to satisfy this query prompt. The LLM may generate a response for the query in accordance with the operations described in FIG. 4.

The analysis circuitry 208 may use the LLM to generate a reason for each response. The reason for a response may be indicative of the reasoning and rationale the LLM identified to determine the binary response for the query. By way of continuing example, in an instance in which the LLM determines the target document section satisfies the aforementioned query prompt such that the response to the query prompt is “yes”, the reason for the response may describe that the target document section addresses the weaknesses found in the validation process and may further, describe the identified weaknesses identified by the LLM in the target document section.

In some embodiments, the query prompt may correspond to an approved query prompt from an approved query prompt list. The approved query prompt list may include a list of query prompts that have been tested and validated for accuracy for use with the LLM. By using approved query prompts, this may help ensure the results from the compliance checklist are accurate. In some embodiments, the approved query prompt list may be stored and/or maintained in an associated storage, such as memory 204. In some embodiments, the analysis circuitry 208 may be configured to validate a query prompt prior to generating a response by accessing the approved query prompt list and determining whether the query prompt included in the compliance requirement document corresponds to an approved query prompt of the approved query prompt list. For example, the analysis circuitry 208 may be configured to determine a similarity score for the query prompt and one or more approved query prompts. In an instance that a similarity score satisfies a similarity score threshold, the analysis circuitry 208 may be configured to determine the query prompt corresponds to an approved query prompt. Alternatively, in an instance no similarity scores satisfy a similarity score threshold, the analysis circuitry 208 may be configured to determine the query prompt does not correspond to an approved query prompt. In some embodiments, this may cause the analysis circuitry 208 to generate a warning for the response or may skip the query altogether in order to avoid query prompts that may yield inaccurate results.

In some embodiments, operations 308 may be performed in accordance with the operations described by FIG. 4. Turning now to FIG. 4, example operations are shown for generating a response to a query prompt. The operations described in FIG. 4 may be performed for each query included in the compliance requirement document.

As shown by operation 402, the apparatus 200 includes means, such as analysis circuitry 208 or the like, for identifying a target document section that corresponds to the query. As described above, each query in the compliance requirement document may include a relevant target document section. The analysis circuitry 208 may identify the target document section that corresponds to the query using the compliance requirement document. In particular, the analysis circuitry 208 may identify a target document section by processing structural elements in the input document, such as titles (e.g., “Executive Summary”) and/or specific formatting style (e.g., titles, underlined text, spacing).

As shown by operation 404, the apparatus 200 includes means, such as analysis circuitry 208 or the like for tokenizing the target document section. The analysis circuitry 208 may tokenize the content of the target document section to generate a plurality of target document section tokens. The analysis circuitry 208 may use any suitable tokenization method to tokenize the target document section. In some embodiments, the analysis circuitry 208 may use sub-word tokenization approaches, vocabulary mapping, contextual tokenization, and/or the like. In some embodiments, the analysis circuitry 208 may further filter out tokens that correspond to stop words (i.e., commonly used words that carry little meaningful information), such as “the,” “is,” “and,” etc. This reduces the overall number of target document section tokens, thereby reducing the overall number of target document section embeddings.

In some embodiments, the analysis circuitry 208 may ensure that the number of resulting target document section tokens for each target document section tokens does not exceed a maximum token limit of the LLM. By first intelligently partitioning the input document into relevant target document sections, this allows the analysis circuitry 208 to generate a total number of target document section tokens that is less than the maximum token limit for the LLM (e.g., around 4000 tokens). Furthermore, by partitioning the input document into target document sections, this ensures the context of the content within a particular input document section is maintained. Ordinarily, the total number of tokens for the entire input document would be larger than the maximum token limit of the LLM, which may cause a target document section of an input document to be split. This would lose the context of the content of the target document section and thus, may make the response to the query inaccurate. Furthermore, by identifying the relevant target document section, the analysis circuitry 208 may tokenize and provide only the content relevant to the query, thereby conserving computational resources and reducing the chance for errors.

In some embodiments, operations 404 may be performed in accordance with the operations described by FIG. 31, which is described in further detail below. In some embodiments, the analysis circuitry 208 may ensure the number of target document section tokens does not exceed a maximum token limit.

As shown by operation 406, the apparatus 200 includes means, such as communications hardware, analysis circuitry 208, or the like for generating a response to the query prompt based on the target document section tokens. In some embodiments, a response to the query prompt may include a binary response, a reason for the binary response, or both. The analysis circuitry 208 may use the LLM to generate a response to the query prompt based on the target document section tokens. In some embodiments, the analysis circuitry 208 may additionally tokenize the query prompt into a plurality of query prompt tokens. The analysis circuitry 208 may then generate a plurality of query prompt embeddings from the plurality of query prompt tokens and generate a plurality of target document section embeddings from the plurality of target document section tokens using any suitable technique. For example, in some embodiments, the analysis circuitry 208 may use Word2Vec, global vectors for word representation (GloVe), FastText, associated embedding models (e.g., bidirectional encoder representations from transformers (BERT)), and/or the like. Alternatively, the analysis circuitry 208 may then provide the plurality of query prompt tokens and the plurality of target document section tokens to the LLM. The LLM, in turn, may transform the plurality of query prompt tokens into query prompt embeddings and may also transform the plurality of target document section tokens into a plurality of target document section embeddings. In either instance, the query prompt embeddings and target document section embeddings may be vector or numerical representations of the query prompt tokens and historical document section tokens, respectively. The embeddings may further include positional encodings such that the sequence of the corresponding tokens is maintained.

In some embodiments, the analysis circuitry 208 may use the communications hardware 206 to provide the plurality of query prompt embeddings and target document section embeddings to the LLM if the LLM did not generate the embeddings. The LLM may then process the query prompt embeddings and target document section embeddings to generate the response. In some embodiments, the LLM may feed the query prompt embeddings into its associated multiple transformer layers of attention mechanisms and feed-forward neural networks. For each transformer layer, a query prompt embedding may be transformed based on the other query prompt embeddings. This may cause the LLM to temporarily adjust its internal state for the duration of processing the query. In some embodiments, the adjustment of the internal state activates certain neurons that are dynamically changed as the LLM processes the query prompt embeddings. This may allow the LLM to understand the query prompt.

The LLM may also process the target document section embeddings to generate the response to the query prompt. In some embodiments, the LLM may be configured to process the target document section embeddings after the query prompt embeddings. The LLM may analyze the target document section embeddings using the adjusted internal state such that the target document section embeddings are analyzed in the context of the query prompt. The LLM may then be configured to generate a response for the query prompt. The response to the query prompt may include a binary response to the query prompt. In some embodiments, the response to the query is categorical, such as “yes” or “no”. By way of continuing example, for a query prompt of “Does the Executive Summary address weaknesses?”, the LLM may determine a binary response of “yes” if the “Executive Summary” target document section includes mention of findings and proposed solutions of identified issues. Alternatively, the LLM may determine a binary response of “no” if the “Executive Summary” target document section does not reference any weaknesses or solutions.

In some embodiments, the LLM may determine a similarity between the query prompt embeddings and the target document section embeddings. As described above, the query prompt embeddings and target document sections embeddings may represent the semantic meaning of the query prompt and target document section, respectively. For example, the LLM may determine a similarity score between the embeddings using a cosine similarity algorithm, a Euclidean distance algorithm, a Manhattan distance algorithm, a Jaccard similarity algorithm, a Pearson Correlation coefficient algorithm, a Hamming distance algorithm, a Mahalanobis Distance algorithm, a Bray-Curtis similar algorithm, a Kullback-Liebler Divergence algorithm, and/or the like. A high similarity score between one or more query prompt embeddings and one or more target document section embeddings may be indicative that the content of the target document aligns well with the query prompt and is therefore compliant. In contrast, a low similarity score may be indicative of mismatch and suggest non-compliance. The LLM may determine the binary response based on whether the similarity score satisfies a similarity score threshold. By way of continuing example, the LLM may determine a high similarity score between query prompt embeddings and target document section embeddings that pertain to text that directly addresses weaknesses.

In some embodiments, the response to the query prompt may also include generate a reason for the response. A reason may be provided in natural language and serve as an interpretation for the binary response. By way of particular example, the LLM may generate a reason of “the Executive Summary explicitly states the weaknesses and proposes corrective actions” when the binary response is “yes”. Alternatively, the LLM may generate a reason of “the Executive Summary does not mention weaknesses or propose any solutions.” In some embodiments, the LLM may further use attention mechanisms to identify the most relevant portions of the target document section embeddings. The LLM may weight these target document section embeddings more heavily when generating the reason.

Returning now to FIG. 3, as shown by operation 310, the apparatus 200 includes means, such as analysis circuitry 208 or the like for generating a compliance checklist. Once the analysis circuitry 208 has used to LLM to generate a response for each query in the compliance requirement document, the analysis circuitry 208 may generate a compliance checklist. Alternatively, the analysis circuitry 208 may generate a compliance checklist once a first response and optionally, a reason for the response for a first query in the compliance requirement document is generated. The analysis circuitry 208 may then provide the compliance checklist (as described in operation 312) such that the compliance checklist may be provided in real-time or near real-time. The analysis circuitry 208 may then iteratively perform operations 308-312 until all queries in the compliance requirement document are completed.

A compliance checklist may be a structured document or report that includes the results of the evaluation of the input document. The compliance checklist may serve as a comprehensive summary to ensure the evaluated input document adheres to standards and provides insights into any deficiencies. In some embodiments, the compliance checklist is a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), and/or the like.

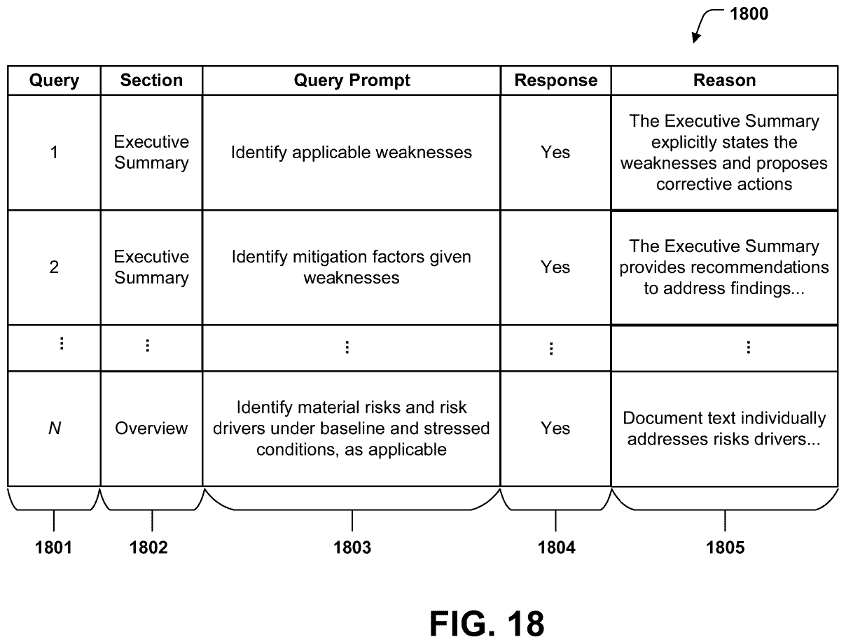

The compliance checklist may include the response for each query prompt. In some embodiments, the compliance checklist may also include the reason for each response. The compliance checklist may further include an indication of the corresponding query, the target document section for the query, and the query prompt used for each query. FIG. 18, which is described in further detail below, depicts an example compliance checklist 1800.

As shown by operation 312, the apparatus 200 includes means, such as memory 204, communications hardware 206, analysis circuitry 208, or the like for providing the compliance checklist. Once the analysis circuitry 208 has generated the compliance checklist, the communications hardware 206 may provide the compliance checklist to a user, such as via a user device (e.g., any one of user devices 106A-106N). The compliance checklist may be formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), or the like. In some embodiments, the user may use an output user interface of the document compliance check application to download, view, or otherwise access the compliance document illustrated in FIG. 18.

In some embodiments, the analysis circuitry 208 may store the compliance checklist for the input document in the document evaluation repository 112, memory 204, or another associated storage repository. In some embodiments, the analysis circuitry 208 may store the compliance checklist in a manner such that it is linked to or associated with the particular input document. For example, the analysis circuitry 208 may store the compliance checklist with a metadata tag that links the document to the corresponding input document. To do so, the analysis circuitry 208 may generate a unique identifier for the input document and/or include details pertaining to the input document (e.g., document title, creation date, version, author, or the like). As another example, in some embodiments the document evaluation repository 112 may use a relational database (e.g., document evaluation repository 112 or another repository) that allows the compliance checklist to be linked to the input document.

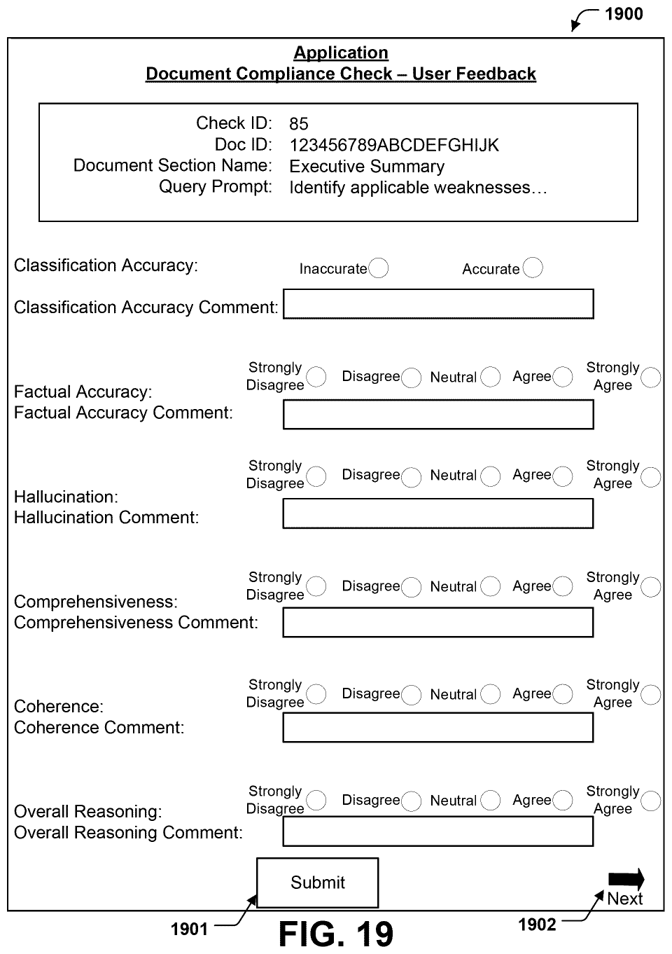

In some embodiments, the user may also use a user feedback mechanism user interface of the document compliance check application to provide feedback on the quality of the response and reason generated for each query. In some embodiments, upon providing the compliance checklist, the communications hardware 206 may further be configured to provide a predefined user feedback document to the user. The user feedback document may solicit feedback from the user regarding the accuracy, robustness, and quality of the response and reason for a given query in the compliance checklist. A user may interact with the user feedback document via a user device (e.g., any one of user devices 106A-106N) and submit the user feedback document. The communications hardware 206 may receive the filled out user feedback document and may store this in the document evaluation repository 112, memory 204, or another storage location. The analysis circuitry 208 may further associated the user feedback document with the associated compliance checklist, such as by using a unique identifier for the compliance checklist and/or using a relational database. This feedback may be used to further fine-tune the LLM, as discussed in greater detail in FIG. 14. An example user feedback mechanism user interface 1900 is illustrated in FIG. 19.

### Example Operations for an Internal Chat Application

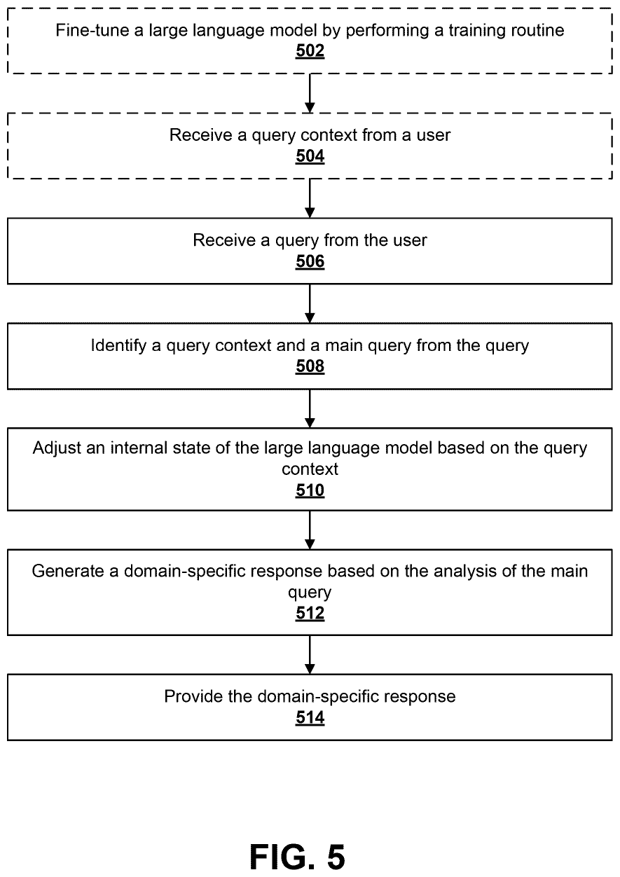

Turning now to FIG. 5, example operations are shown for generating a domain-specific response for a query provided by a user. Example embodiments described herein provide domain-specific responses tailored to a user's query. Example embodiments provide enhanced accuracy of domain-specific responses by allowing for a user to separately provide a query context and a query. The query context may be used by the LLM to adjust its internal state before processing the query. This may minimize ambiguity in the domain-specific response and ensure the response is highly relevant to the user's intent behind the query. This may also reduce computational overhead by allowing the LLM to analyze only relevant aspects of the query in light of the query context.

Optionally, as shown by operation 502, the apparatus 200 includes means, such as training circuitry 210 or the like, for fine-tuning a LLM by performing a training routine. In some embodiments, the training circuitry 210 may perform the training routine in accordance with the operations described in FIGS. 14-15, as described in greater detail below.

Optionally, as shown by operation 504, the apparatus 200 includes means, such as communications hardware 206 or the like for receiving a query context from the user. In some embodiments, a user may provide a query context prior to providing a query. The query context may describe instructions and/or context for an operation to be performed on a main query. For example, a query context may be “summarize the following text in 150 words or less”. Thus, the query context may be separated from the main query, which may include the content to be analysed in view of the query context.

The communications hardware 206 may receive the query context from a user, such as via a user device (e.g., any one or user devices 106A-106N). In some embodiments, a user may use the user device to interact with an application selection interface and select an internal chat application as illustrated in FIG. 16, which is described in further detail below. The user may use an input user interface 2200 of the internal chat application to provide the query context separately from the main query, as illustrated in FIG. 22.

As shown by operation 506, the apparatus 200 includes means, such as communications hardware 206 or the like for receiving a query from the user. A user may provide a query that includes a main query and, in some embodiments, a query context. The main query may be the content that the user wishes to be analysed, modified, or otherwise interacted with by the LLM. In some embodiments, the query may include both the query context and the main query. Alternatively, as described above, the user may first provide a separate query context such that the query may only include the main query.

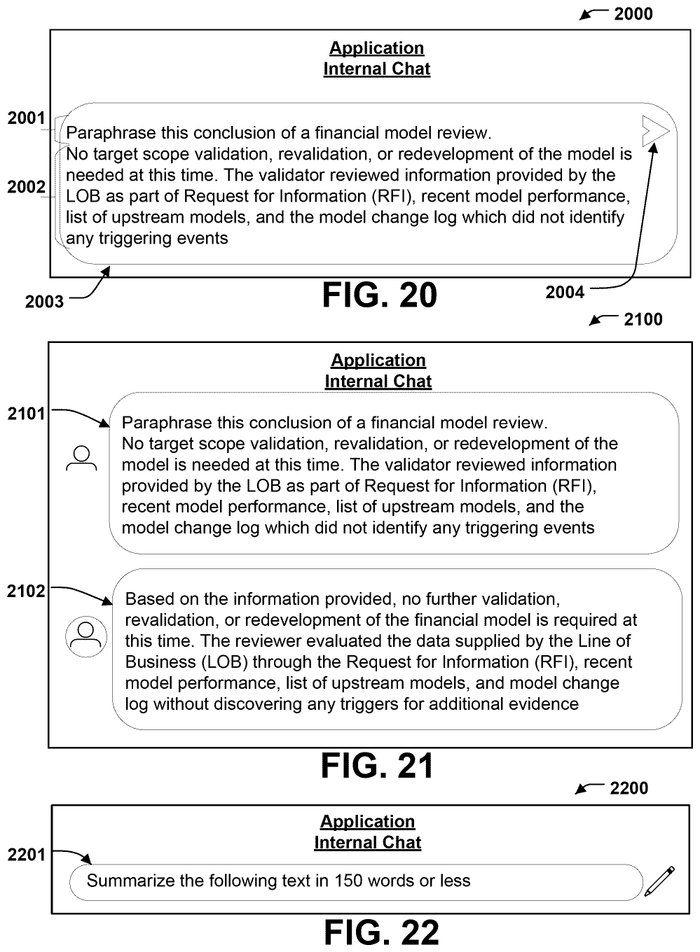

The communications hardware 206 may receive the query from a user, such as via a user device (e.g., any one or user devices 106A-106N). In some embodiments, a user may use the user device to interact with an application selection interface and select an internal chat application as illustrated in FIG. 16, which is described in further detail below. The user may use an input user interface of the internal chat application to provide the query. An example user interface 2000 of the internal chat application is illustrated in FIG. 20, and in this case, includes both the query context and the main query.

As shown by operation 508, the apparatus 200 includes means, such as processor 202, memory 204, analysis circuitry 208, or the like, for identifying a query context and a main query from the query. The analysis circuitry 208 may identify a query context and a main query. In an instance a separate query context was received by the communications hardware 206, the analysis circuitry 208 may identify the query context from the received query context and the main query from the subsequently received query.

Alternatively, in an instance in which the query includes both the query context and main query, the analysis circuitry 208 may be configured to identify the query context from the main query and then partition the query into the query context and main query. In some embodiments, the analysis circuitry 208 may be configured to identify the query context based on a text sequence, text structure, and/or the like. For example, the analysis circuitry 208 may be configured to associate certain terms, sentence structures, characters, or the like with a query context. Additionally, the analysis circuitry 208 may be configured to identify particular terms, delimiters, demarcations, or the like that indicate the start and/or end of the query context. For example, the analysis circuitry 208 may be configured to identify that a query context is likely included as the first full sentence of the query. In some embodiments, the analysis circuitry 208 may be configured to identify the query context based on certain command terminology that is often associated with a query context.

As shown by operation 510, the apparatus 200 includes means, such as analysis circuitry 208 or the like for adjusting an internal state of the LLM based on the query context.

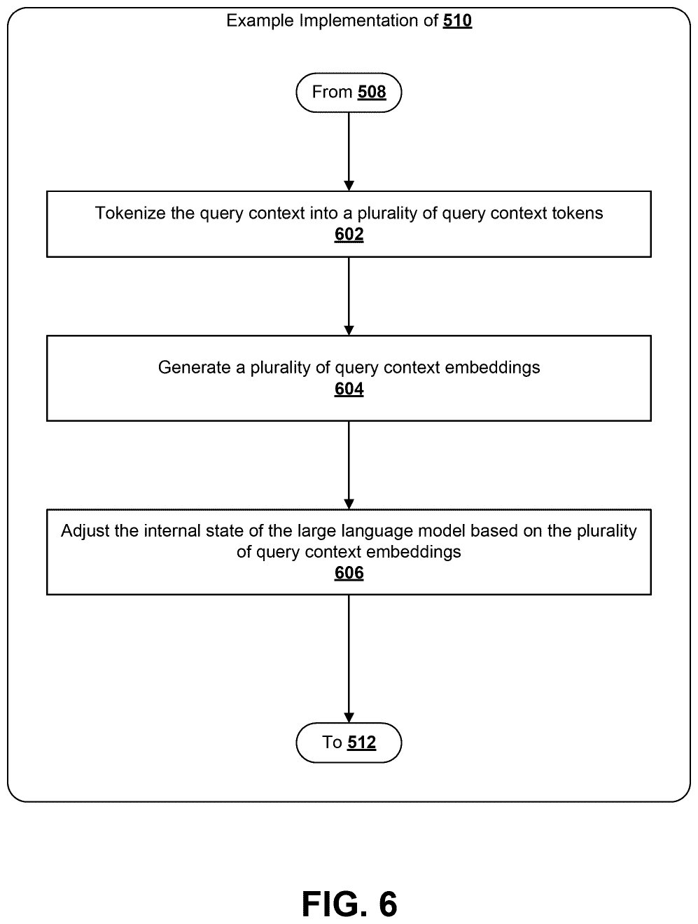

Once the query context has been identified, the analysis circuitry 208 may use the LLM to process the query context. In particular, the LLM may adjust its internal state based on the query context. As described in greater detail in FIG. 6, the analysis circuitry 208 may tokenize the query context and the LLM may use query context embeddings to adjust its internal state.

In some embodiments, operations 510 may be performed in accordance with the operations described by FIG. 6. Turning now to FIG. 6, example operations are shown for adjusting the internal state of the LLM.

As shown by operation 602, the apparatus 200 includes means, such as analysis circuitry 208 or the like for tokenizing the query context into one or more query context tokens. The analysis circuitry 208 may tokenize the query context into one or more query context tokens. The analysis circuitry 208 may use any suitable tokenization method to tokenize the query context. For example, the analysis circuitry 208 may use sub-word tokenization approaches, vocabulary mapping, contextual tokenization, and/or the like.

As shown by operation 604, the apparatus 200 includes means, such as analysis circuitry 208 or the like for generating a plurality of query context embeddings. In some embodiments, the analysis circuitry 208 may generate the plurality of query context embeddings from the plurality of query context tokens using any suitable technique. For example, in some embodiments, the analysis circuitry 208 may use Word2Vec, GloVe, FastText, associated embedding models (e.g., BERT), and/or the like. Alternatively, the analysis circuitry 208 may then provide the plurality of query context tokens to the LLM. The LLM, in turn, may transform the plurality of query context tokens into query context embeddings. In either instance, the plurality of query context embeddings may be a vector or numerical representation of the plurality of query context tokens.

As shown by operation 606, the apparatus 200 includes means, such as communications hardware 206, analysis circuitry 208, or the like for adjusting the internal state of the LLM based on the query context embeddings. The analysis circuitry 208 may use the LLM to adjust its internal state based on the plurality of query context embeddings. In some embodiments, the communications hardware 206 may provide the query context embeddings to the LLM if the LLM did not generate the query context embeddings. In some embodiments, the LLM may feed the plurality of query context embeddings into its associated multiple transformer layers of attention mechanisms and feed-forward neural networks. For each transformer layer, a query context embedding may be transformed based on the other query context embeddings. The LLM may activate certain neurons that are dynamically changed as the LLM processes the context query. This may allow the LLM to understand the query context. The adjusted internal state of the model may only be temporarily maintained for the duration of processing the main query and/or subsequent queries (e.g., subsequently received query contexts and main queries).

Returning now to FIG. 5, as shown by operation 512, the apparatus 200 includes means, such as analysis circuitry 208 or the like for generating a domain-specific response based on the main query. The analysis circuitry 208 may use the LLM to generate a domain-specific response based on the main query. As described in more detail in FIGS. 14-15, the LLM may be trained using domain-specific training data that captures the rules, criteria, formatting, guidelines, etc. of the institution. Thus, the response generate for the main query may be tailored based on this domain-specific data. These types of domain-specific contexts may be captured in the domain-specific training data such that the LLM may be configured to process, analyze, and generate data within the particular domain of interest.

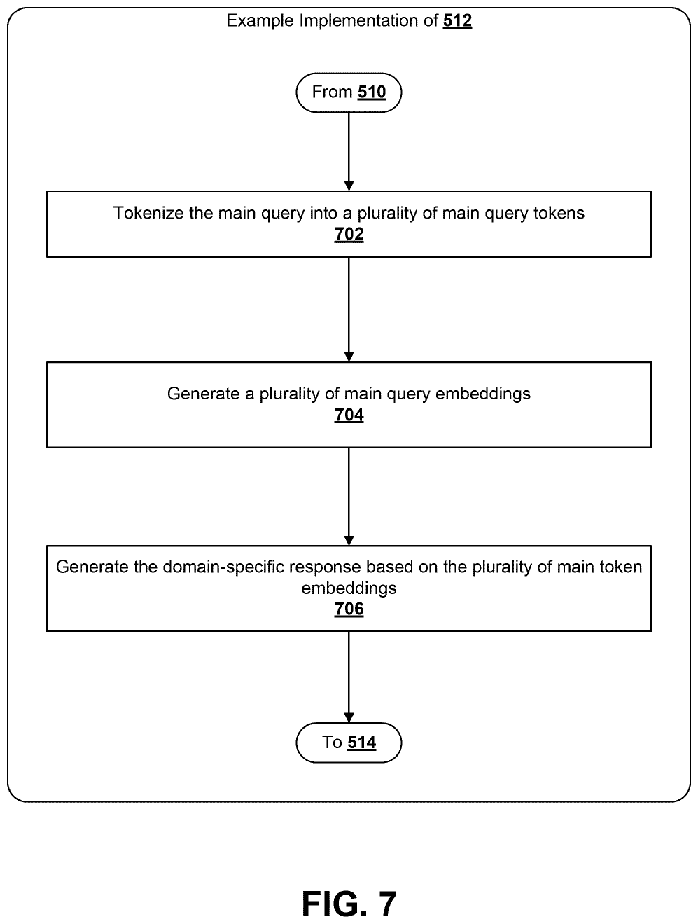

In some embodiments, operations 512 may be performed in accordance with the operations described by FIG. 7. Turning now to FIG. 7, example operations are shown for generating the domain-specific response based on main query embeddings.

As shown by operation 702, the apparatus 200 includes means, such as analysis circuitry 208 or the like for tokenizing the main query into a plurality of main query tokens. The analysis circuitry 208 may tokenize the main context into a plurality of main query tokens. The analysis circuitry 208 may use any suitable tokenization method to tokenize the main query. In some embodiments, the analysis circuitry 208 may use sub-word tokenization approaches, vocabulary mapping, contextual tokenization, and/or the like.

As shown by operation 704, the apparatus 200 includes means, such as analysis circuitry 208 or the like for generating a plurality of main query embeddings. In some embodiments, the analysis circuitry 208 may generate a plurality of main query embeddings from the plurality of main query tokens using any suitable technique. For example, in some embodiments, the analysis circuitry 208 may use Word2Vec, GloVe, FastText, associated embedding models (e.g., BERT), and/or the like. Alternatively, the analysis circuitry 208 may then provide the plurality of main query tokens to the LLM. The LLM, in turn, may transform the plurality of main query tokens into main query embeddings and. The plurality of main query embeddings may be a vector or numerical representation of the plurality of main query tokens.

As shown by operation 706, the apparatus 200 includes means, such as communications hardware 206, analysis circuitry 208, or the like for generating the domain-specific response based on the plurality of main query embeddings. In some embodiments, the analysis circuitry 208 may use the communications hardware 206 to provide the plurality of main query embeddings to the LLM if the LLM did not generate the plurality of main query embeddings. The analysis circuitry 208 may use the LLM to generate the domain-specific response based on the main query embeddings. In some embodiments, the LLM may feed the main query embeddings into its associated multiple transformer layers of attention mechanisms and feed-forward neural networks. For each transformer layer, a main query embedding may be transformed based on the other main query embeddings and/or based on the context query embeddings. In some embodiments, the LLM may predict new tokens that align with the main query as well as the instructions in the query context. In some embodiments, the LLM may iteratively refine intermediate domain-specific responses until it has generated a suitable domain-specific response.

Returning now to FIG. 5, as shown by operation 514, the apparatus 200 includes means, such as communications hardware 206, analysis circuitry 208, or the like for providing the domain-specific response. The LLM may output the domain-specific response to the analysis circuitry 208. In some embodiments, the analysis circuitry 208 may receive the domain-specific response using communications hardware 206. Once the analysis circuitry 208 has used the LLM to generate the domain-specific response, the communications hardware 206 may provide the domain specific response to a user, such as via a user device (e.g., any one of user devices 106A-106N). In some embodiments, the user may use an output user interface 2100 of the internal chat application to view, or otherwise access the domain-specific response illustrated in FIG. 21.

In some embodiments, the user may also use a user feedback mechanism user interface of the internal chat application to provide feedback on the quality of the domain-specific response. This feedback may be used to further fine-tune the LLM.

### Example Operations for a Document Chat Application

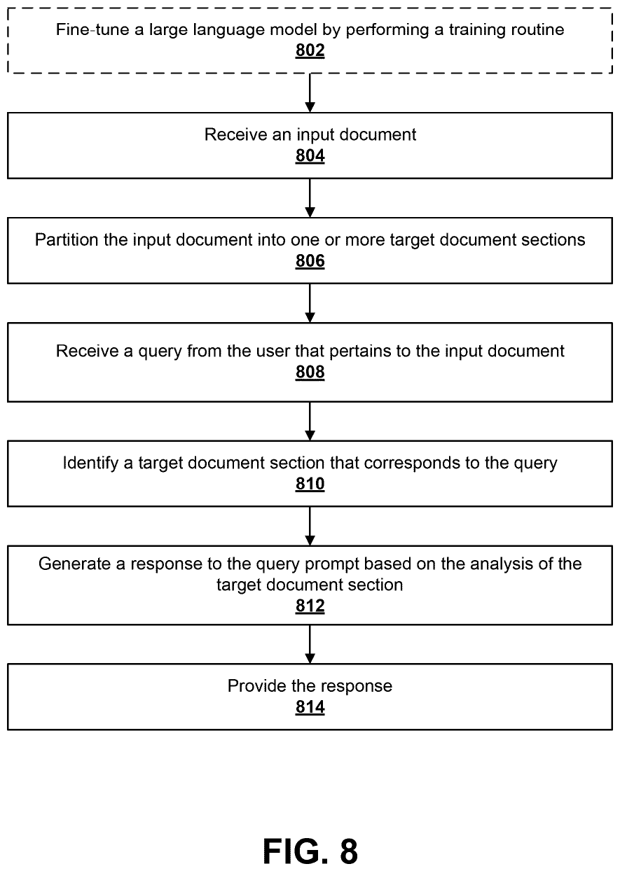

Turning now to FIG. 8, example operations are shown for generating a response in response to a user query that pertains to an input document. Example embodiments provide a robust mechanism for interacting with specific document sections of an input document and in doing so, provide users with precise and contextually-relevant answers that reduce ambiguity and increase operational efficiency. Example embodiments further enable real-time response generation and provision, thereby providing users with immediate insights into their documents. The generated responses are tailored to specific user queries and input document contexts, thus providing highly personalized and actionable insights.

Example embodiments also intelligently partition an input document into target sections, thereby maintaining contextual integrity of the content during subsequent processing by an LLM. In doing so, example embodiments effectively overcome the LLMs maximum token limit, thereby ensuring that even lengthy input documents can be processed without sacrificing context or accuracy. Furthermore, only relevant target document sections that correspond to the query are processed. This targeted query approach optimizes computational resource usage by minimizing unnecessary processing of irrelevant document sections and also reducing the time required to generate a response.

Optionally, as shown by operation 802, the apparatus 200 includes means, such as training circuitry 210 or the like for fine-tuning a LLM by performing a training routine. In some embodiments, the training circuitry 210 may perform the training routine in accordance with the operations described in FIGS. 14-15, as described in greater detail below.

As shown by operation 804, the apparatus 200 includes means, such as communications hardware 206 or the like for receiving an input document. An input document may be a document a user may provide and desire to interact with. The input document may be a document formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), and/or the like.

The communications hardware 206 may receive the input document from a user, such as via a user device (e.g., any one or user devices 106A-106N). In some embodiments, a user may use the user device to interact with an application selection interface and select a document chat application as illustrated in FIG. 16, which is described in further detail below. The user may use an input user interface of the document chat application to provide the input document.

As shown by operation 806, the apparatus 200 includes means, such as analysis circuitry 208 or the like for partitioning the input document into one or more target document sections. In some embodiments, the analysis circuitry 208 may be used to partition the input document into one or more target document sections.

In some embodiments, the analysis circuitry 208 may use a pre-processing model to pre-process the input document to remove or replace particular characters (e.g., special characters), remove certain formatting (e.g., convert all characters to lowercase or uppercase), and/or the like. The analysis circuitry 208 may be configured to identify a target document section based on a particular text sequence that is used to demarcate the beginning of a target document section. In some embodiments, operation 806 may be performed in a substantially similar manner as described in operation 306 of FIG. 3

As shown by operation 808, the apparatus 200 includes means, such as communications hardware 206 or the like for receiving a query from the user that pertains to the input document. In some embodiments, the communications hardware 206 may receive a query from the user via a user device (e.g., any one of user devices 106A-106N). A user may also provide a query that pertains to the input document. The query may include a query prompt. The query prompt may describe a query from the user that pertains to the input document.

In some embodiments, the query prompt may correspond to an approved query prompt from an approved query prompt list. The approved query prompt list may include a list of query prompts that have been tested and validated for accuracy for use with the LLM. By using approved query prompts, this may help ensure the results from the compliance checklist are accurate. In some embodiments, the approved query prompt list may be stored and/or maintained in an associated storage, such as memory 204. In some embodiments, the analysis circuitry 208 may be configured to validate a query prompt prior to generating a response by accessing the approved query prompt list and determining whether the query prompt included in the compliance requirement document corresponds to an approved query prompt of the approved query prompt list. For example, the analysis circuitry 208 may be configured to determine a similarity score for the query prompt and one or more approved query prompts. In an instance that a similarity score satisfies a similarity score threshold, the analysis circuitry 208 may be configured to determine the query prompt corresponds to an approved query prompt. Alternatively, in an instance no similarity scores satisfy a similarity score threshold, the analysis circuitry 208 may be configured to determine the query prompt does not correspond to an approved query prompt. In some embodiments, this may cause the analysis circuitry 208 to generate a warning for the response or may skip the query altogether in order to avoid query prompts that may yield inaccurate results.

As shown by operation 810, the apparatus 200 includes means, such as analysis circuitry 208 or the like for identifying a target document section that corresponds to the query. In some embodiments, the query prompt included in the query received in operation 806 may include an indication of a document section of interest. In some embodiments, the analysis circuitry 208 may process the query prompt to identify the target document section to which the query prompt pertains. In some embodiments, operation 810 may be performed in a substantially similar manner as described in operation 402 of FIG. 4.

As shown by operation 812, the apparatus 200 includes means, such as analysis circuitry 208 or the like for generating a response to the query prompt based on the target document section. The analysis circuitry 208 may tokenize the content of the target document section to generate a plurality of target document section tokens and tokenize the query prompt into a plurality of query prompt tokens. The analysis circuitry 208 may use the LLM to generate a response to the query prompt based on the plurality of target document section tokens and plurality of query prompt tokens.

In some embodiment, the analysis circuitry 208 may then generate a plurality of query prompt embeddings from the plurality of query prompt tokens and generate a plurality of target document section embeddings from the plurality of target document section tokens using any suitable technique. For example, in some embodiments, the analysis circuitry 208 may use Word2Vec, GloVe, FastText, associated embedding models (e.g., BERT), and/or the like. Alternatively, in some embodiments, the LLM may transform the plurality of query prompt tokens into a plurality of query prompt embeddings and/or the plurality of target document section embeddings into target document section embeddings. The LLM may feed the plurality of query prompt embeddings into its associated multiple transformer layers of attention mechanisms and feed-forward neural networks. For each transformer layer, a query prompt embedding may be transformed based on the other query prompt embeddings. This may cause the LLM to temporarily adjust its internal state for the duration of processing the query. In some embodiments, the adjustment of the internal state activates certain neurons that are dynamically changed as the LLM processes the query prompt embeddings. This may allow the LLM to understand the query prompt. In some embodiments, operation 812 may be substantially similar to operations 510 and 512 of FIG. 5, operations 602-606 of FIG. 6, and operations 702-706 of FIG. 7.

As shown by operation 814, the apparatus 200 includes means, such as communications hardware 206 or the like for providing the response to the query. The communications hardware 206 may then provide the response to a user, such as via a user device (e.g., any one of user devices 106A-106N). In some embodiments, the user may use an output user interface of the document chat application to view, or otherwise access the response. In some embodiments, operation 814 may be performed in a substantially similar manner as described in operation 514 of FIG. 5.

In some embodiments, the user may also use a user feedback mechanism user interface of the document chat application to provide feedback on the quality of the response to the query. This feedback may be used to further fine-tune the LLM.

### Example Operations for a Data Summary Application

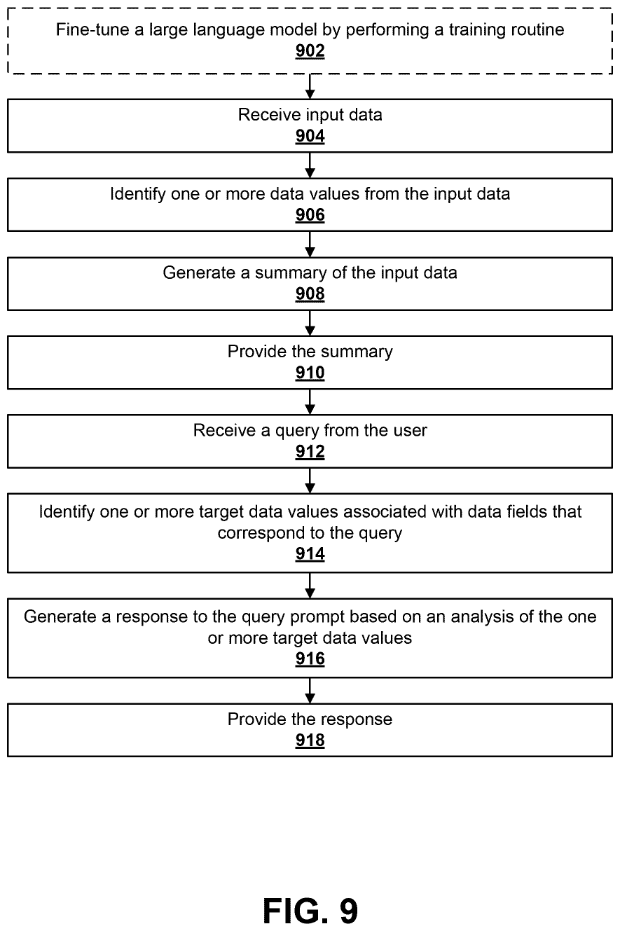

Turning now to FIG. 9, example operations are shown for generating a summary for input data. Example embodiments leverage a fine-tuned LLM to automatically generate summaries for input data, thereby reducing the time and effort required for users to manually analyze and summarize large and/or complex datasets. Example embodiments described herein support a diverse input of data formats, which provides a versatile system capable of handling a wide range of input data. Additionally, example embodiments support user queries to extract targeted insights from the data, thereby enabling dynamic exploration of input data in a manner not previously possible.

Example embodiments also intelligently identify specific data fields and values from within the input data, thereby ensuring the summaries are relevant and focused on important information. This targeted approach minimizes irrelevant content within summaries, thereby improving the quality of the response and also reducing the time required to generate a response.

Optionally, as shown by operation 902, the apparatus 200 includes means, such as training circuitry 210 or the like for fine-tuning a LLM by performing a training routine. In some embodiments, the training circuitry 210 may perform the training routine in accordance with the operations described in FIGS. 14-15, as described in greater detail below.

As shown by operation 904, the apparatus 200 includes means, such as communications hardware 206 or the like for receiving input data. The communications hardware 206 may receive the input data in a variety of structured formats. For example, the input data be formatted as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), and/or the like. In some embodiments, the input data may include one or more input data values. Each input data value may correspond to an input data field.

The communications hardware 206 may receive the input data from a user, such as via a user device (e.g., any one or user devices 106A-106N). In some embodiments, a user may use the user device to interact with an application selection interface and select a data summary application as illustrated in FIG. 16, which is described in further detail below.

As shown by operation 906, the apparatus 200 includes means, such as analysis circuitry 208 or the like for identifying one or more data values from the input data. In some embodiments, each data value may correspond to a particular data field. The analysis circuitry 208 may use file-specific parsing methods to extract the one or more data values from the received input data. For example, if the input data is formatted as a spreadsheet file (e.g., XLS or XLSX extension), the analysis circuitry 208 may be configured to map cells, rows, and columns to structured data fields. As another example, if the input data is formatted as a delimited text file (e.g., comma separated values (CSV) or tab separated values (TSV)), the analysis circuitry 208 may identify data values by detecting separators and mapping values to a data field. As another example, the analysis circuitry 208 may analyze tags, attributes, and/or a hierarchy to identify data values from the input data.

In some embodiments, the analysis circuitry 208 may use tokenization techniques and/or natural language processing (NLP) techniques to identify input data. For example, the analysis circuitry 208 may use these techniques to process text-formatted input data and identify input data based on an analysis of the text. In some embodiments, the analysis circuitry 208 may generate a vector, matrix, or other data structure that includes the corresponding data values.

The analysis circuitry 208 may further map the data values to a corresponding data field. In some embodiments, the analysis circuitry 208 may identify a data field based on the structure of the input data (e.g., data labels, headers, or other identifier).

As shown by operation 908, the apparatus 200 includes means, such as analysis circuitry 208 or the like for generating a summary of the input data. The analysis circuitry 208 may further be configured to use the LLM to generate a summary of the input data based on the input data values. The summary of the input may provide an overview of the provided input data. In some embodiment, the LLM may process the input data values to generate the summary of the input data.

In particular, the analysis circuitry 208 may tokenize the one or more data values into a plurality of data value tokens. The LLM may process these data value tokens to generate a summary of the input data. In some embodiments, the LLM may generate a statistical summary of the data values, such as averages, sums, or distributions for data fields than correspond to numerical data values. In some embodiments, the statistical summary may further include a frequency analysis, indicative of the number of times a data value recurred within the input data. In some embodiments, the LLM may additionally, or alternatively, generate a textual summary of the data values. This textual summary may include key elements, such as dates, numbers, names, or locations for various data values.

As shown by operation 910, the apparatus 200 includes means, such as communications hardware 206 or the like for providing the summary of the input data. The communications hardware 206 may then provide the summary of the input data to a user, such as via a user device (e.g., any one of user devices 106A-106N). The summary of the input data may be formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), or the like. In some embodiments, the user may use an output user interface of the data summary application to download, view, or otherwise access the summary of the input data.

As shown by operation 912, the apparatus 200 includes means, such as communications hardware 206 or the like for receiving a query from the user. In some embodiments, the communications hardware 206 may receive a query from the user. A user may also provide a query that pertains to the input data. The query may include a query prompt. The query prompt may describe a query from the user that pertains to the input data and/or the summary.

In some embodiments, the query prompt may correspond to an approved query prompt from an approved query prompt list. The approved query prompt list may include a list of query prompts that have been tested and validated for accuracy for use with the LLM. By using approved query prompts, this may help ensure the results from the compliance checklist are accurate. In some embodiments, the approved query prompt list may be stored and/or maintained in an associated storage, such as memory 204. In some embodiments, the analysis circuitry 208 may be configured to validate a query prompt prior to generating a response by accessing the approved query prompt list and determining whether the query prompt included in the compliance requirement document corresponds to an approved query prompt of the approved query prompt list. For example, the analysis circuitry 208 may be configured to determine a similarity score for the query prompt and one or more approved query prompts. In an instance that a similarity score satisfies a similarity score threshold, the analysis circuitry 208 may be configured to determine the query prompt corresponds to an approved query prompt. Alternatively, in an instance no similarity scores satisfy a similarity score threshold, the analysis circuitry 208 may be configured to determine the query prompt does not correspond to an approved query prompt. In some embodiments, this may cause the analysis circuitry 208 to generate a warning for the response or may skip the query altogether in order to avoid query prompts that may yield inaccurate results.

As shown by operation 914, the apparatus 200 includes means, such as analysis circuitry 208 or the like for identifying one or more target data values associated with data fields that correspond to the query. In some embodiments, the query prompt included in the query received in operation 912 may include an indication of a target data values and/or target data fields of interest. In some embodiments, the analysis circuitry 208 may process the query prompt to identify the target data fields and/or target data values to which the query prompt pertains.

As shown by operation 916, the apparatus 200 includes means, such as analysis circuitry 208 or the like for generating a response to the query based on an analysis of the one or more target data values. In some embodiments, the analysis circuitry 208 may tokenize the target data values to generate a plurality of target data value tokens. The analysis circuitry 208 may use any suitable tokenization method to tokenize the target data values. In some embodiments, the analysis circuitry 208 may use sub-word tokenization approaches, vocabulary mapping, contextual tokenization, and/or the like.

The analysis circuitry 208 may use the LLM to generate a response to the query prompt based on the plurality of target data value tokens. In some embodiments, the analysis circuitry 208 may additionally process and tokenize the query prompt into query prompt tokens prior to processing the target data value tokens. In some embodiments, the analysis circuitry 208 may transform the query prompt tokens into query prompt embeddings and/or transform the target data value tokens into target data value embeddings using any suitable technique, such as Word2Vec, GloVe, FastText, associated embedding models (e.g., BERT), and/or the like. Alternatively, in some embodiments, the LLM may transform the query prompt tokens into query prompt embeddings and/or target data value tokens into target data value embeddings. In some embodiments, the LLM may feed the query prompt embeddings into its associated multiple transformer layers of attention mechanisms and feed-forward neural networks. For each transformer layer, a query prompt embedding may be transformed based on the other query prompt embeddings. This may cause the LLM to temporarily adjust its internal state for the duration of processing the query. In some embodiments, the adjustment of the internal state activates certain neurons that are dynamically changed as the LLM processes the query prompt embeddings. This may allow the LLM to understand the query prompt. The LLM may process the target data value embeddings to generate the response to the query. In some embodiments, the LLM may be configured to process the target data value embeddings after the query prompt embeddings. The LLM may analyze the target data value embeddings using the updated internal state such that the target data value embeddings are analyzed in the context of the query prompt. The LLM may then be configured to generate a response for the query prompt. The response to the query prompt may include an answer to the query prompt and in some embodiments, a reason for the answer. In some embodiments, operation 916 may be substantially similar to operations 510 and 512 of FIG. 5, operations 602-606 of FIG. 6, and operations 702-706 of FIG. 7.

As shown by operation 918, the apparatus 200 includes means, such as communications hardware 206 or the like, for providing the response to the query. The communications hardware 206 may then provide the response to a user, such as via a user device (e.g., any one of user devices 106A-106N). In some embodiments, the user may use an output user interface of the data summary application to view, or otherwise access the response.

In some embodiments, the user may also use a user feedback mechanism user interface of the data summary application to provide feedback on the quality of the data summary and/or the response to the query. This feedback may be used to further fine-tune the LLM.

### Example Operations for a Document Summary Application

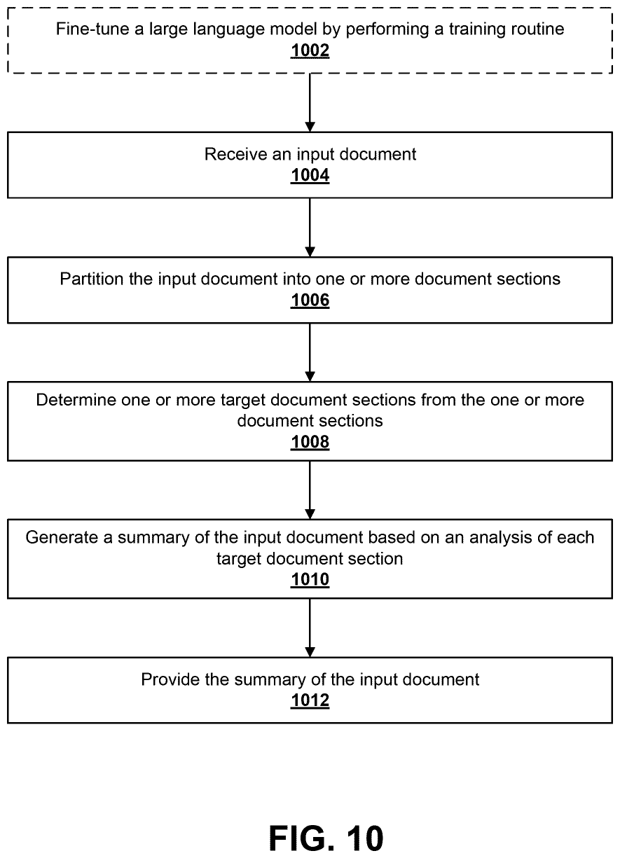

Turning now to FIG. 10, example operations are shown for generating a summary for an input document. Example embodiments leverage a fine-tuned LLM to automate input document summarization, thereby saving users significant time and effort as compared to manual summarization. Example embodiments also intelligently partition an input document into target sections, thereby maintaining contextual integrity of the content during subsequent processing by an LLM. In doing so, example embodiments effectively overcome the LLMs maximum token limit, thereby ensuring that even lengthy input documents can be processed without sacrificing context or accuracy. Furthermore, only relevant target document sections that correspond to the query are processed. This targeted query approach optimizes computational resource usage by minimizing unnecessary processing of irrelevant document sections and also reducing the time required to generate a response.

Optionally, as shown by operation 1002, the apparatus 200 includes means, such as training circuitry 210 or the like for fine-tuning a LLM by performing a training routine. In some embodiments, the training circuitry 210 may perform the training routine in accordance with the operations described in FIGS. 14-15, as described in greater detail below.

As shown by operation 1004, the apparatus 200 includes means, such as communications hardware 206 or the like for receiving an input document. An input document may be a document a user may provide and desire to have summarized. The input document may be a document formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), and/or the like.

The communications hardware 206 may receive the input document from a user, such as via a user device (e.g., any one or user devices 106A-106N). In some embodiments, a user may use the user device to interact with an application selection interface and select a document summary application as illustrated in FIG. 16, which is described in further detail below.

As shown by operation 1006, the apparatus 200 includes means, such as analysis circuitry 208 or the like for partitioning the input document into one or more document sections. In some embodiments, the analysis circuitry 208 may be used to partition the input document into one or more document sections. In some embodiments, operation 1006 may be performed in a substantially similar manner as described in operation 306 of FIG. 3

As shown by operation 1008, the apparatus 200 includes means, such as analysis circuitry 208 or the like for determining one or more target sections from the one or more document sections. The analysis circuitry 208 may determine one or more target document sections from the one or more document sections. In particular, the one or more target document sections may be document sections inferred to have substantial content and/or content of interest for a document summary. Thus, irrelevant or extraneous document sections that may have a low impact on the rest of the input document may not be included as a target document section. This may reduce the computational resources required generate a summary of the input document. In some embodiments, the analysis circuitry 208 may filter irrelevant document sections based on the particular text sequence that is used to demarcate the beginning of a target document section. For example, in some embodiments, the analysis circuitry 208 may be configured to ignore certain document section titles, such as “References” or “Acknowledgements”, which may be considered low priority for the summary.

As shown by operation 1010, the apparatus 200 includes means, such as analysis circuitry 208 or the like for generating a summary of the input document based the target document section. The analysis circuitry 208 may tokenize the content of the target document sections to generate a plurality of target document section tokens for each target document section. The analysis circuitry 208 may use any suitable tokenization method to tokenize the target document section. In some embodiments, the analysis circuitry 208 may use sub-word tokenization approaches, vocabulary mapping, contextual tokenization, and/or the like.

In some embodiments, the analysis circuitry 208 may transform the plurality of target document section tokens into a plurality of target document embeddings using any suitable technique, such as Word2Vec, GloVe, FastText, associated embedding models (e.g., BERT), and/or the like. Alternatively, the analysis circuitry 208 may then provide the plurality of target document section tokens to the LLM. The LLM may transform the plurality of target document section tokens into a plurality of target document embeddings. The LLM may generate the summary of the input document based on the target document section embeddings. The summary of the input document may summarize the key points of the input document for the target document sections.

As shown by operation 1012, the apparatus 200 includes means, such as communications hardware 206 or the like for providing the summary of the input document. The communications hardware 206 may then provide the summary of the input document to a user, such as via a user device (e.g., any one of user devices 106A-106N). The summary of the input document may be formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), or the like. In some embodiments, the user may use an output user interface of the document summary application to download, view, or otherwise access the summary of the input document.

In some embodiments, the user may also use a user feedback mechanism user interface of the document summary application to provide feedback on the quality of the summary of the input document. This feedback may be used to further fine-tune the LLM.

### Example Operations for a Document Change Detection Application

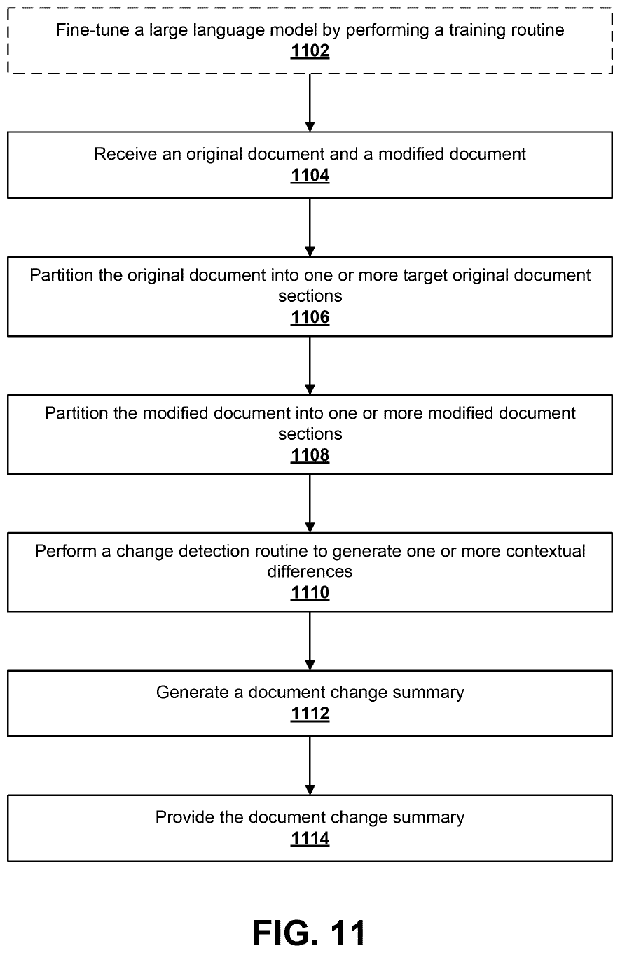

Turning now to FIG. 11, example operations are shown for providing a document change summary. Example embodiments described herein automate the comparison between an original and modified document, thereby significantly reducing the time and effort for manual review. Further, example embodiments do not simply highlight the strict differences between the documents, but further generate contextual differences between the documents that explain how changes impact the overall document. This enhances the understanding for all involved parties, which may be particularly important for legal, compliance, regulatory, and/or contractual documents.

Optionally, as shown by operation 1102, the apparatus 200 includes means, such as training circuitry 210 or the like for fine-tuning a LLM by performing a training routine. In some embodiments, the training circuitry 210 may perform the training routine in accordance with the operations described in FIGS. 14-15, as described in greater detail below.

As shown by operation 1104, the apparatus 200 includes means, such as communications hardware 206 or the like for receiving an original document and a modified document. The communications hardware 206 may receive an original document and a modified document from a user. The original document may correspond to a previous version of the modified document and the modified document may be an updated version of the original document that includes one or more changes.

The original document and modified document may be a document formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), and/or the like.

The communications hardware 206 may receive the original document and the modified document from a user, such as via a user device (e.g., any one or user devices 106A-106N). In some embodiments, a user may use the user device to interact with an application selection interface and select a document change detection application as illustrated in FIG. 16, which is described in further detail below. The user may use an input user interface of the document change detection application to provide the original document and modified document.

As shown by operation 1106, the apparatus 200 includes means, such as analysis circuitry 208 or the like for partitioning the original document into one or more target original document sections. In some embodiments, the analysis circuitry 208 may be used to partition the original document into one or more target original document sections. In some embodiments, operation 1106 may be performed in a substantially similar manner as described in operation 306 of FIG. 3.

As shown by operation 1108, the apparatus 200 includes means, such as analysis circuitry 208 or the like for partitioning the modified document into one or more target modified document sections. In some embodiments, the analysis circuitry 208 may be used to partition the modified document into one or more modified original document sections. The analysis circuitry 208 may be configured to partition the modified document into one or more target modified document sections. In some embodiments, one or more of the target modified document sections correspond to a target original document section. A target modified document section corresponding to a target original document section may not be included in a modified document. Similarly, a target original document section corresponding to a target modified document section may not be included in an original document. In some embodiments, operation 1108 may be performed in a substantially similar manner as described in operation 306 of FIG. 3.

As shown by operation 1110, the apparatus 200 includes means, such as analysis circuitry 208 or the like for performing a change detection routine to generate one or more contextual differences. The analysis circuitry 208 may use the LLM to perform a change detection routine using the target original document sections and target modified document sections. By performing the change detection routine, the LLM may generate one or more contextual differences that describe a contextual difference between the original document and the modified document. A contextual change may describe any change in context of the language, data, media, etc. between the original document and modified document. Furthermore, the LLM may generate a contextual change such that it describes how a change between the original document and modified document impacts the rest of the document. For example, if a clause included in the original document was removed in the subsequent modified document, the LLM may generate the contextual difference that indicates the removal of this clause causes the modified document to no longer be in compliance with institution policies and latter modified document sections referring to the removed clause are inaccurate.

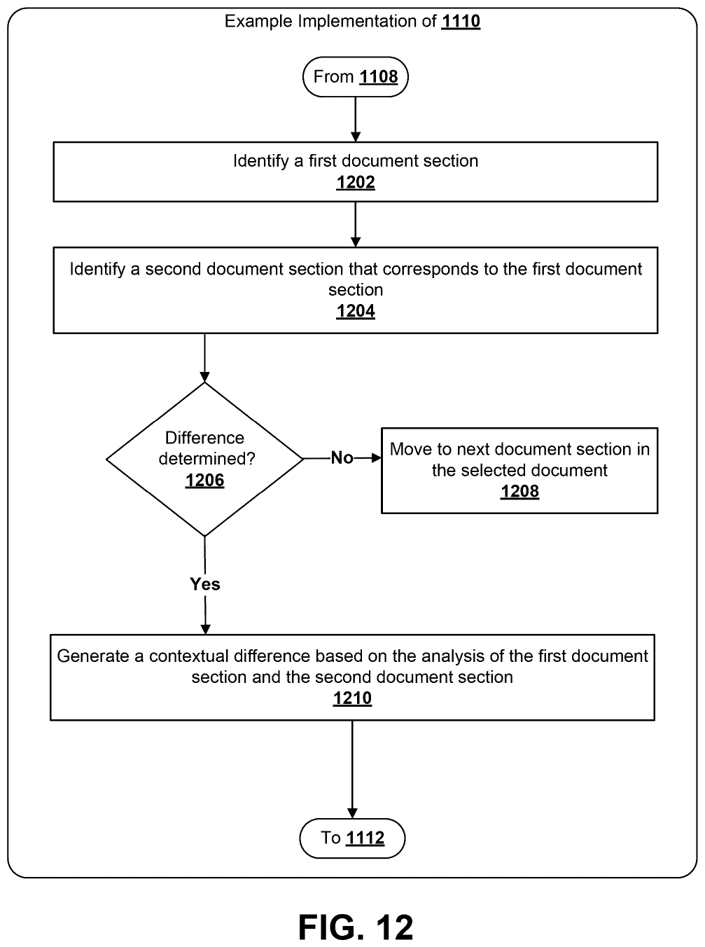

In some embodiments, operations 1110 may be performed in accordance with the operations described by FIG. 12. Turning now to FIG. 12, example operations are shown for performing the change detection routine to generate the one or more contextual differences.

As shown by operation 1202, the apparatus 200 includes means, such as analysis circuitry 208 or the like for identifying a first document section. The analysis circuitry 208 may be configured to identify a first document section that is either a target original document section or a target modified document section. The analysis circuitry 208 may be configured to identify the first document section based on a particular text sequence that is used to demarcate the beginning of a target document section.

As shown by operation 1204, the apparatus 200 includes means, such as analysis circuitry 208 or the like for identifying a second document section. The analysis circuitry 208 may then be configured to identify a second document section that is either a target original document section or a target modified document section. The second document section must be from a different document than the first document section. For example, if the first document section is a target original document section from the original document, the second document section must be a target modified document section from the modified document. Additionally, the second document section may correspond to the first document section. The analysis circuitry 208 may be configured to identify the second document section based on a particular text sequence that is used to demarcate the beginning of a target document section and based on the first document section.

As shown by operation 1206, the apparatus 200 includes means, such as analysis circuitry 208 or the like for determining whether a difference is determined between the first document section and the second document section. The analysis circuitry 208 may compare the content first document section and the second document section to determine whether a difference exists between the sections. In some embodiments, the analysis circuitry 208 may use the LLM to determine whether a difference exists between the sections.

In some embodiments, the analysis circuitry 208 may tokenize the first document section into a plurality of first document section tokens and may tokenize the second document section into a plurality of second document section tokens. In some embodiments, the analysis circuitry 208 may generate a plurality of first document section embeddings from the first document section tokens and a plurality of second document section embeddings from the second document section tokens using any suitable technique, such as Word2Vec, GloVe, FastText, associated embedding models (e.g., BERT), and/or the like. Alternatively, the analysis circuitry may provide the first document section tokens and second document section tokens to the LLM. The LLM may then generate a plurality of first document section embeddings from the first document section tokens and a plurality of second document section embeddings from the second document section tokens. The LLM may perform a similarity analysis on the plurality of first document section embeddings and second document section embeddings to determine whether there is a difference between the first document section and the second document section. The LLM may determine that no difference exists if the similarity score indicates a complete match. Otherwise, the LLM may determine a difference exists.

In an instance no difference is determined, the process proceeds to operation 1208. As shown by operation 1208, the apparatus 200 includes means, such as processor 202, memory 204, analysis circuitry 208, or the like, for moving to a next document section in the selected document.

In an instance a difference is determined, the process proceeds to operation 1210. As shown by operation 1210, the apparatus 200 includes means, such as analysis circuitry 208 or the like for generating a contextual difference based on an analysis of the first document section and the second document section. The analysis circuitry 208 may use the LLM to generate the contextual difference between the first section and the second section. The LLM may use the similarity score determine between the first document section embeddings and the second document section embeddings to identify where the document sections differ. The LLM may use an attention mechanism to identify the impact of the differences and generate the contextual difference for the sections.

Returning now to FIG. 11, as shown by operation 1112, the apparatus 200 includes means, such as analysis circuitry 208 or the like for generating a document change summary. The analysis circuitry 208 may use the LLM to generate the document change summary. The document change summary may include the one or more contextual differences determined between the original document and modified document. Additionally, the document change summary may include a location for each contextual differences in a respective document. Thus, a user may immediately view the impacted areas of the affected documents.

As shown by operation 1114, the apparatus 200 includes means, such as communications hardware 206 or the like for providing the document change summary. The communications hardware 206 may then provide the document change summary to a user, such as via a user device (e.g., any one of user devices 106A-106N). The document change summary may be formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), or the like. In some embodiments, the user may use an output user interface of the document change detection application to download, view, or otherwise access the document change summary.

In some embodiments, the user may also use a user feedback mechanism user interface of the document change detection application to provide feedback on the quality of the document change summary. This feedback may be used to further fine-tune the LLM.

### Example Operations for a New Document Generation Application

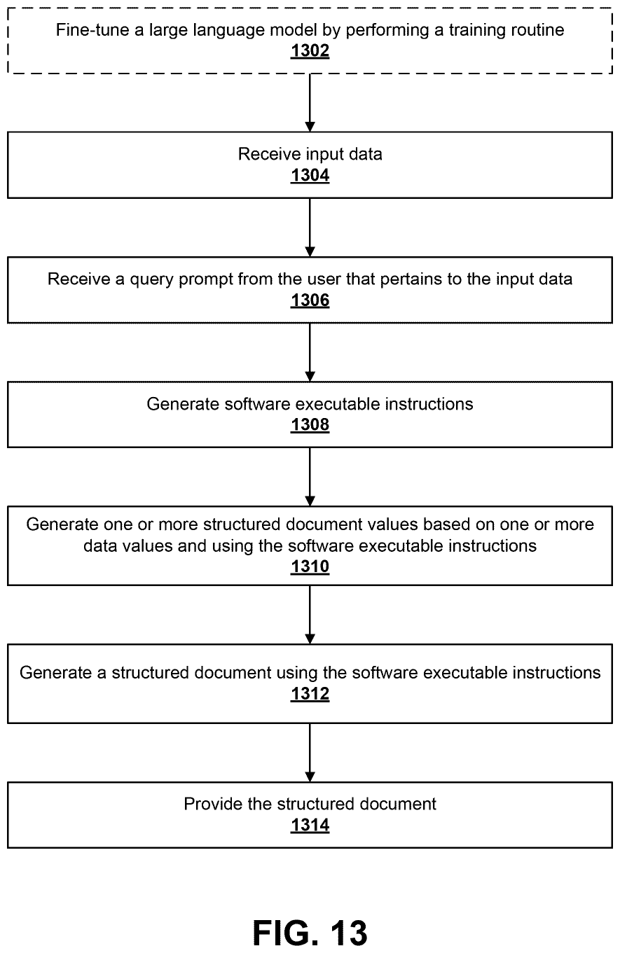

Turning now to FIG. 13, example operations are shown for generating a structured document using received input data. Example embodiments described herein automate the process of converting input data into structured documents, thereby streamlining operations and improving workflow efficiency. A user may provide a query prompt to customize the formatting and transformation of the input data, thereby allowing for the generation of structured documents that align with user intent.

Optionally, as shown by operation 1302, the apparatus 200 includes means, such as training circuitry 210 or the like for fine-tuning a LLM by performing a training routine. In some embodiments, the training circuitry 210 may perform the training routine in accordance with the operations described in FIGS. 14-15, as described in greater detail below.

As shown by operation 1304, the apparatus 200 includes means, such as communications hardware 206 or the like for receiving input data. The communications hardware 206 may receive the input data in a variety of structured formats. For example, the input data be formatted as a HyperText Markup Language (such files with as HTML or HTM extensions), a spreadsheet (such as files with XLS or XLSX extensions), and/or the like. In some embodiments, the input data may include one or more input data values. Each input data value may correspond to an input data field. The input data may also have associated metadata.

The communications hardware 206 may receive the input data from a user, such as via a user device (e.g., any one or user devices 106A-106N). In some embodiments, a user may use the user device to interact with an application selection interface and select a new document generation application as illustrated in FIG. 16, which is described in further detail below.

As shown by operation 1306, the apparatus 200 includes means, such as communications hardware 206 or the like for receiving a query prompt from the user that pertains to the input data. In some embodiments, the communications hardware 206 may receive a query prompt from the user. The query prompt may describe a query from the user that pertains to the input data.

In some embodiments, the query prompt may correspond to an approved query prompt from an approved query prompt list. The approved query prompt list may include a list of query prompts that have been tested and validated for accuracy for use with the LLM. By using approved query prompts, this may help ensure the results from the compliance checklist are accurate. In some embodiments, the approved query prompt list may be stored and/or maintained in an associated storage, such as memory 204. In some embodiments, the analysis circuitry 208 may be configured to validate a query prompt prior to generating a response by accessing the approved query prompt list and determining whether the query prompt included in the compliance requirement document corresponds to an approved query prompt of the approved query prompt list. For example, the analysis circuitry 208 may be configured to determine a similarity score for the query prompt and one or more approved query prompts. In an instance that a similarity score satisfies a similarity score threshold, the analysis circuitry 208 may be configured to determine the query prompt corresponds to an approved query prompt. Alternatively, in an instance no similarity scores satisfy a similarity score threshold, the analysis circuitry 208 may be configured to determine the query prompt does not correspond to an approved query prompt. In some embodiments, this may cause the analysis circuitry 208 to generate a warning for the response or may skip the query altogether in order to avoid query prompts that may yield inaccurate results.

As shown by operation 1308, the apparatus 200 includes means, such as analysis circuitry 208 or the like for generating software executable instructions. The analysis circuitry 208 may use the LLM to generate software executable instructions. The software executable instructions may include instructions to use the input data to generate a structured document described by the query prompt. For example, the received input data may be structured as a table with a plurality of data values for data fields. The query prompt may indicate the user wants to transform the input data included in the table into a graph. Thus, the LLM may generate software executable instructions that may be executed to performing this transformation.

The analysis circuitry 208 may generate a plurality of query prompt tokens based on the query prompt. In some embodiments, the analysis circuitry may transform the plurality of query prompt tokens into a plurality of query prompt embeddings and the plurality of input data tokens into a plurality of input data embeddings, using any suitable technique, such as Word2Vec, GloVe, FastText, associated embedding models (e.g., BERT), and/or the like. Alternatively, the analysis circuitry 208 may provide the plurality query prompt tokens and/or plurality of input data tokens to the LLM. The LLM may transform the plurality of query prompt tokens into a plurality of query prompt embeddings and the plurality of input data tokens into a plurality of input data embeddings. The LLM may feed the plurality of query prompt embeddings into its associated multiple transformer layers of attention mechanisms and feed-forward neural networks. For each transformer layer, a query prompt embedding may be transformed based on the other query prompt embeddings. This may cause the LLM to temporarily adjust its internal state for the duration of processing the query. In some embodiments, the adjustment of the internal state activates certain neurons that are dynamically changed as the LLM processes the query prompt embeddings. The LLM may process the plurality of target document embeddings to generate the software executable instructions.

As shown by operation 1310, the apparatus 200 includes means, such as automation circuitry 212 or the like for generating one or more structured document values based on the one or more data values and using the software executable instructions. In some embodiments, the automation circuitry 212 may execute the software execution instructions and generate one or more structured data values. For example, the software execution instructions may cause the automation circuitry 212 to modify the one or more data values included in the input data. The automation circuitry 212 may modify the one or more data values using the software execution instructions to generate the structured document values.

In some embodiments, the software execution instructions may cause the automation circuitry 212 to generate a new document that includes structured input data. For example, the software execution instructions may cause unstructured input data to be transformed into a structured format, such as a table, graph, image, etc.

As shown by operation 1312, the apparatus 200 includes means, such as automation circuitry 212 or the like for generating a structured document using the software executable instructions. Automation circuitry 212 may be configured to receive the software executable instructions and execute the software executable instructions. Execution of these software executable instructions may cause the automation circuitry 212 to generate a structured document based on the data values included in the input data. For example, the automation circuitry 212 may execute the software executable instructions to generate the graph of the tabular input data.

As shown by operation 1314, the apparatus 200 includes means, such as communications hardware 206 or the like for providing the structured document. The communications hardware 206 may then provide the structured document to a user, such as via a user device (e.g., any one of user devices 106A-106N). In some embodiments, the user may use an output user interface of the new document generation application to view, or otherwise access the structured document. The structured document may be formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), or the like. In some embodiments, the user may use an output user interface of the new document generation application to download, view, or otherwise access the structured document.

In some embodiments, the user may also use a user feedback mechanism user interface of the new document generation application to provide feedback on the quality of the structured document. This feedback may be used to further fine-tune the LLM.

### Example Operations for Efficiently Storing Historical Documents

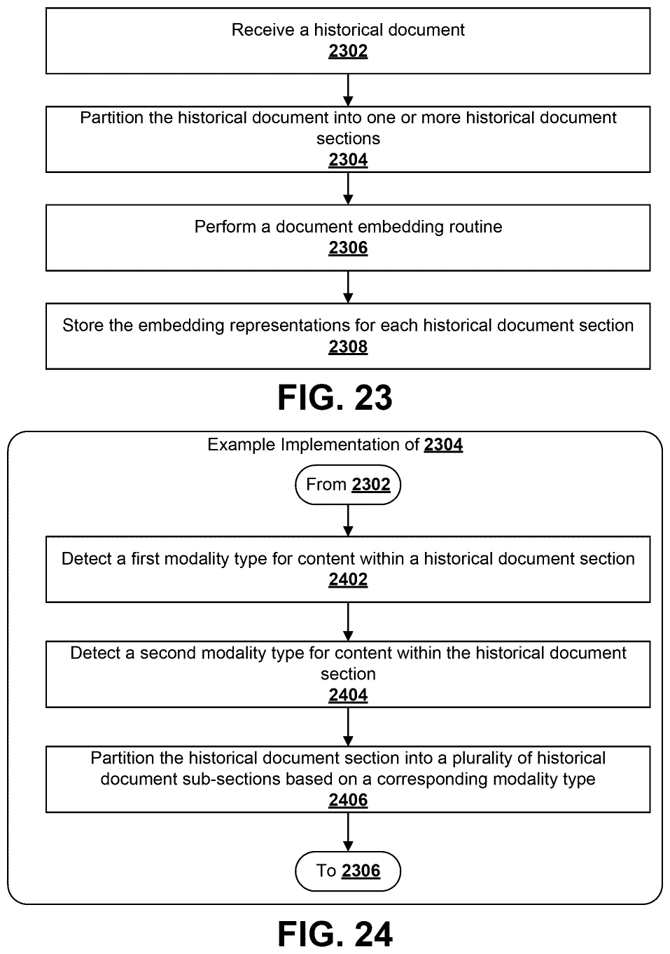

Turning now to FIG. 23, example operations are shown for efficiently storing a received historical document. Example embodiments also allow authorized users to intelligently store and manage historical documents, such as MDDs and/or MVDs, in an associated historical document repository. In particular, a received historical document may be partitioned into one or more historical document sections, which ensures the section's context is preserved for processing by the LLM, which may have token size limitations. A document embedding routine is performed on the historical document sections, wherein the content of a historical document is tokenized into a plurality of historical document section tokens and transformed into a plurality of historical document section embeddings. By doing so, a historical document is transformed from high-dimensional data into lower-dimensional vectors, thereby reducing the storage requirements while still preserving the content's semantic meaning. These compact historical document section embeddings are then stored in an associated historical document repository, thereby reducing storage requirements while enabling efficiency real-time content retrieval through similarity-based searching techniques.

Additionally, example embodiments contemplate the ability to partition a historical document section into historical document subsections based on detected content modality type within a historical document section. Advantageously, by partitioning a given historical document section into a plurality of historical document subsections, example embodiments enable the content within the historical document to be processed and stored in a more efficient manner. This resulting historical document subsections are transformed into historical document section tokens, which in turn are used to generate a plurality of historical document section embeddings for the historical document subsection. These historical document section embeddings are then stored in the associated historical document repository. By partitioning a historical document section by modality and separately generating historical document section embeddings, subsequent historical document repository indexing may be optimized and thus, result in faster and more efficient query speeds. For example, storing historical document section embeddings of different modality types may allow apparatus 200 to perform parallel processing techniques and query a historical document repository for multiple modalities simultaneously, resulting in faster and more efficient query retrievals. In some embodiments, the plurality of historical document section embeddings may be processed by different LLMs, which may be selected based on a corresponding modality type, thereby resulting in optimized processing of historical document section embeddings. Example embodiments further allow for targeted query for specific types of content (e.g., text, tables, images, audio, images, or the like).

Optionally, although not shown in FIG. 23, the apparatus 200 may include means, such as training circuitry 210 or the like for fine-tuning a LLM by performing a training routine prior to performing the operations described in FIG. 23. In some embodiments, the training circuitry 210 may perform the training routine in accordance with the operations described in FIGS. 14-15, as described in greater detail below.

As shown by operation 2302, the apparatus 200 includes means, such as communications hardware 206 or the like, for receiving a historical document. The communications hardware 206 may receive a historical document from a user device (e.g., any one of user devices 106A-106N). The historical document may be a document formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), and/or the like. In some embodiments, only authorized users, such as software developers, managers, compliance offers, etc., may be enabled to provide the historical document to communications hardware 206. As described in further detail below, this helps ensure that the document evaluation repository 112stores only legitimate historical documents.

In some embodiments, a historical document is guide that describes principles, standards, procedures, etc. for a specific domain of operation. In some embodiments, a historical document is a MDD. A MDD may provide a framework that describes the development lifecycle of models (e.g., design, implementation, testing, deployment), relevant standards, versioning of code, documentation of testing results, dependencies between models and/or model components, and/or the like. In some embodiments, a historical document may be a MVD. A MVD may be used to ensure a model is performing as intended and complies with regulatory and/or business standards. A MVD may include validation criteria, testing frameworks, an audit trail for changes made to the model, and documentation of biases, limitations, or risks. Alternatively, a historical document may be any other type of document.

As shown by operation 2304, the apparatus 200 includes means, such as analysis circuitry 208 or the like for partitioning the historical document into one or more historical document sections. In some embodiments, the analysis circuitry 208 may be used to partition the document into one or more historical document sections. The analysis circuitry 208 may use a pre-processing model to pre-process the historical document to remove or replace particular characters (e.g., special characters), remove certain formatting (e.g., convert all characters to lowercase or uppercase), and/or the like. The analysis circuitry 208 may be configured to identify a historical document section based on a particular text sequence that is used to demarcate the beginning of a historical document section.

For example, the analysis circuitry 208 may be configured to identify the start of a first historical document section by identifying the text sequence “Introduction”. The analysis circuitry 208 may be configured to identify the end of the first historical document section by identifying a next text sequence “Model Overview”. The content between the text sequence “Introduction” and “Model Overview’ and in some embodiments, the first text sequence “Introduction”, may be identified as the first historical document section. In some embodiments, the analysis circuitry 208 may further be configured to identify the historical document section by analysing the formatting of a text sequence. For example, the analysis circuitry 208 may be configured to identify the text sequence that is capitalized, underlined, formatted in a particular style (e.g., a “title” style in a word processing formatted document), a lack of additional characters until a next line (e.g., only the text sequence on a particular line), and/or the like. In some embodiments, the analysis circuitry 208 may further partition the historical document based on the modality of the content within a particular historical document section, as described in more detail in FIG. 24.

In some embodiments, operations 2304 may be performed in accordance with the operations described by FIG. 24. Turning now to FIG. 24, example operations are shown for partitioning a historical document section based on the modality type of content. The example operations described in FIG. 24 may be performed for each historical document section of the one or more historical document subsections

As shown by operation 2402, the apparatus 200 includes means, such as analysis circuitry 208 or the like for detecting a first modality type for content within a historical document section. The analysis circuitry 208 may use a classification model to process the content from a given historical document section. The classification model may be a rules-based model or, in some embodiments a machine learning model, that is configured to detect modality types within the received content of the historical document section. The classification model may be configured with predefined modality types, such as text, tabular data, image, audio, video, and/or the like.

The classification model may be trained using supervised learning techniques. For example, the classification model may be provided training data, such as documentation content that is annotated with modality type labels. This may allow the classification model to learn the characteristics associated with each modality type. For example, the classification model may identify use features associated with the content, such as word density, font type, character encoding, pixel patterns, spatial layouts, embedded tags (e.g., audio tags and video tags), and metadata to identify the particular modality type of content.

The classification model may process the content of the historical document section and identify a first modality type based on the associated features of the content. For example, the classification model may check for optical character recognition (OCR) readable text or native text encoding to determine whether a portion of the content corresponds to a text modality type. As another example, the classification model may identify whether metadata within the historical document section includes tags indicative of a table and/or determine whether the historical document section includes grid-like patterns (e.g., horizontal and vertical lines that form a table structure) to determine whether a portion of the content corresponds to a tabular data modality type. As another example, the classification model may identify whether bitmap patterns or image file formats are present within the content to determine whether a portion of the content corresponds to an image modality type. As another example, the classification model may determine whether the historical document section includes embedded audio waveforms or file extensions, such as .mp3 or .wav, to determine whether a portion of the content corresponds to an audio file. As another example, the classification model may identify whether the content includes video-specific metadata, such as .mp4 or .avi file extensions, to determine whether a portion of the content corresponds to a video modality type.

In some embodiments, the classification model may process the content of the historical document section in a sequential manner. Thus, the classification model may detect a first modality type for a first portion of the content within the historical document section.

As shown by operation 2404, the apparatus 200 includes means, such as analysis circuitry 208 or the like for detecting a second modality type for content within the historical document section. A given historical document section may include content that corresponds to more than one modality type. For example, a historical document section may include text and a table, which may correspond to a text modality type and a tabular modality type, respectively. As described above, the classification model may process the content in a sequential manner. In some embodiments, the classification model may detect a second modality type that is different than the first modality type. By way of continuing example, the classification model may detect that a first portion of the content of the historical document section corresponds to a text modality type and may detect that a second portion of the historical document section corresponds to an image modality type.

As shown by operation 2406, the apparatus 200 includes means, such as analysis circuitry 208 or the like for partitioning the historical document section into a plurality of historical document subsections based on a corresponding modality type. The analysis circuitry 208 may receive the classification of modality type of the content in the historical document section from the classification model. The analysis circuitry 208 may then be configured to partition the document section into a plurality of historical document subsections based on the corresponding modality type. By way of continuing example, the analysis circuitry 208 may be configured to partition the historical document section into two historical document subsections, where one historical document subsection includes the content corresponding to the text modality type and the other historical document subsection includes the content corresponding to the tabular data modality type.

Once the analysis circuitry 208 has partitioned the historical document section into a plurality of historical document subsections, these historical document subsections may be treated as individual historical document sections for subsequent operations. However, metadata within the plurality of historical document subsections may indicate the relationships between the historical document subsections. For instance, the plurality of historical document subsections may each include metadata that associates the subsections with the same heading, subheading, section number, page number, location, etc. within the historical document. Thus, the relationship between the historical document subsections of the same historical document section is preserved.

It will be appreciated that although only two modality types are described, any number of modality types may be detected in a given historical document section and used to partition the historical document section into historical document subsections.

Returning now to FIG. 23, as shown by operation 2306, the apparatus 200 includes means, such as analysis circuitry 208 or the like for performing a document embedding routine. The analysis circuitry 208 may perform the document embedding routine to generate an embedding representation of a historical document section for each historical document section in the historical document.

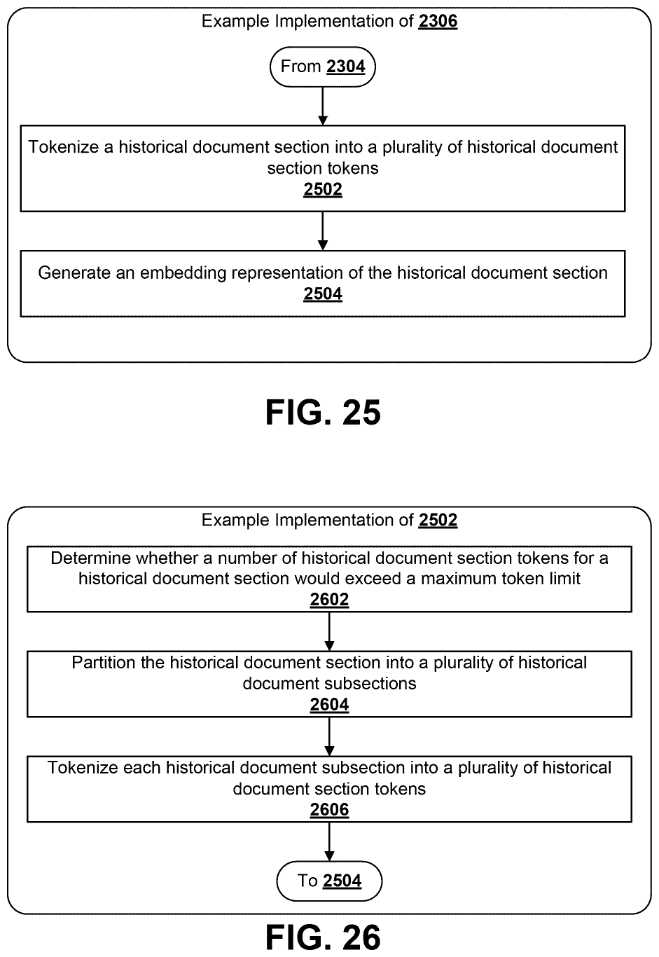

In some embodiments, operations 2306 may be performed in accordance with the operations described by FIG. 25. Turning now to FIG. 25, example operations are shown for generating a plurality of historical document section embeddings.

As shown by operation 2502, the apparatus 200 includes means, such as analysis circuitry 208 or the like for tokenizing a historical document section into a plurality of historical document section tokens. The analysis circuitry 208 may use any suitable tokenization method to tokenize the historical document section. In some embodiments, the analysis circuitry 208 may tokenize a historical document section based on the corresponding modality type. For example, the analysis circuitry 208 may use sub-word tokenization approaches, vocabulary mapping, contextual tokenization, and/or the like for a historical document section and/or historical document subsection that corresponds to a text modality type. As another example, the analysis circuitry 208 may use content tokenization, structural tokenization, and/or the like for a historical document section and/or historical document subsection that corresponds to a tabular data modality type. As another example, the analysis circuitry 208 may use pixel-level tokenization, patch-level tokenization, semantic tokenization (e.g., to identify high-level features such as depicted objects in an image), and/or the like for a historical document section and/or historical document subsection that corresponds to an image modality type. As yet another example, the analysis circuitry 208 may use segment audio and/or video files based on the temporal sequence, extract features from each segment, and tokenize each extracted feature for a historical document section and/or historical document subsection that corresponds to an image modality type.

In some embodiments, the analysis circuitry 208 may further filter out historical document section tokens that correspond to stop words (i.e., commonly used words that carry little meaningful information), such as “the,” “is,” “and,” etc. This reduces the overall number of historical document section tokens, thereby reducing the overall number of historical document section embeddings.

In some embodiments, operations 2502 may be performed in accordance with the operations described by FIG. 26. Turning now to FIG. 26, example operations are shown for tokenizing a historical document section.

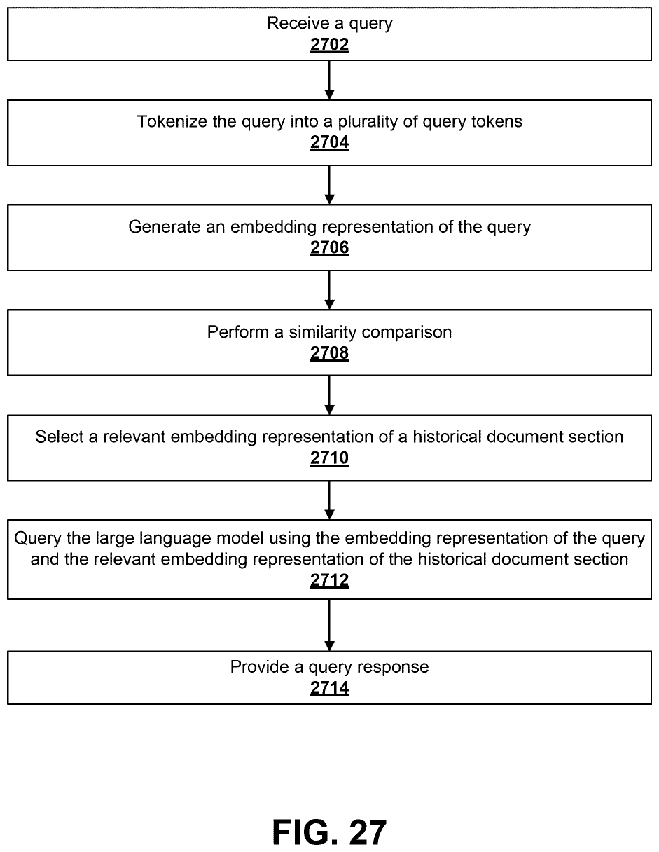

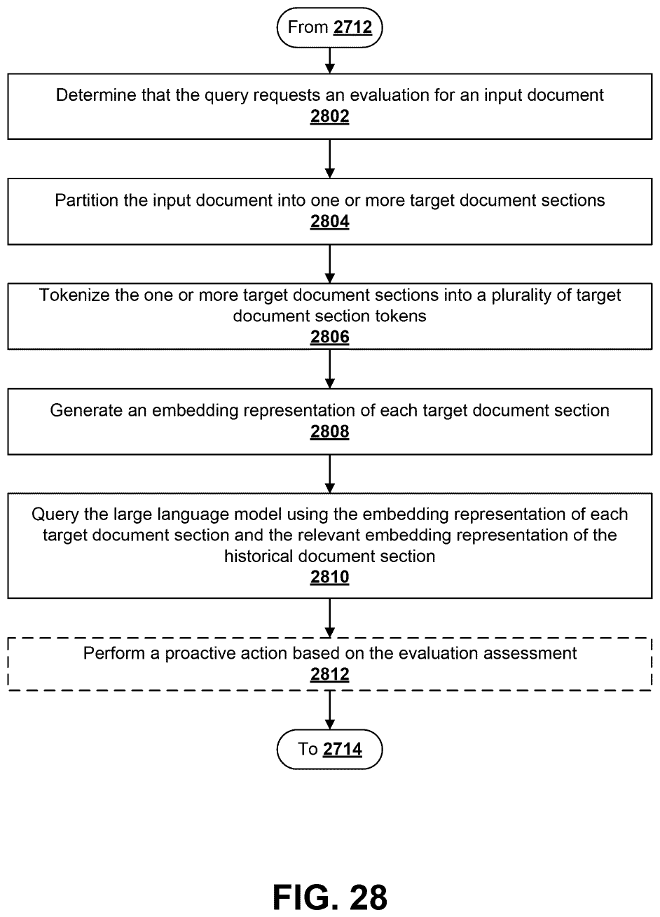

As shown by operation 2602, the apparatus 200 includes means, such as analysis circuitry 208 or the like for determining whether a number of historical document section tokens for a historical document section would exceed a maximum token limit. In some embodiments, an LLM associated with apparatus 200 may have a maximum token size limit. For example, this limit may be around 4000 tokens. The analysis circuitry 208 may determine whether a resulting number of tokens generated for a given historical document section would exceed this maximum token size limit. This helps to prevent issues with subsequent operations, such as when handling queries as described in FIGS. 27 and 28.

As shown by operation 2604, the apparatus 200 includes means, such as analysis circuitry 208 or the like for partitioning the historical document section into a plurality of target document subsections. If the analysis circuitry 208 determines that tokenizing a historical document section would exceed the maximum token size limit, the analysis circuitry 208 may further partition the historical document section into a plurality of historical document subsections. By partitioning the historical document section into historical document subsections, this ensures the context of the content within a particular historical document section is maintained. This prevents the historical document section from being split in an undesirable way.

In some embodiments, the analysis circuitry 208 may partition the historical document section based on the structure and/or layout of the historical document section. In some embodiments, the analysis circuitry 208 may be configured to identify structural indicators that are indicative of boundaries, such as paragraphs, sentences, subsections, etc. and use these structural indicators to partition the historical document section into a plurality of historical document subsections. For example, the analysis circuitry 208 may be configured to identify document structures by identifying line breaks, indentation, text alignment, capitalization cues, and/or tags in markup language, if applicable. By way of particular example, the analysis circuitry 208 may determine that a historical document section exceeds the maximum token size limit and would cause a paragraph within in the historical document section to be split. In response, the analysis circuitry 208 may partition the historical document section into a first historical document subsection that contains content before the paragraph and a second historical document subsection that includes the paragraph and content after the paragraph. In this way, the analysis circuitry 208 prevents the paragraph from being split in an undesirable manner and thereby maintains the context of the paragraph.

As shown by operation 2606, the apparatus 200 includes means, such as analysis circuitry 208 or the like for tokenizing each historical document subsection into a plurality of historical document section tokens. The analysis circuitry 208 may then tokenize each target document subsection into a plurality of document section tokens. The analysis circuitry 208 may tokenize each target document subsection in a substantially similar manner as described in operation 2502 of FIG. 25.

Returning now to FIG. 25, as shown by operation 2504, the apparatus 200 includes means, such as memory 204, analysis circuitry 208 or the like for generating an embedding representation of the historical document section. In some embodiments, the analysis circuitry 208 may then generate a plurality of historical document section embeddings from the plurality of historical document section tokens using any suitable technique. For example, in some embodiments, the analysis circuitry 208 may use Word2Vec, GloVe, FastText, associated embedding models (e.g., BERT), and/or the like. Alternatively, in some embodiments, the analysis circuitry 208 may provide the plurality of historical document section tokens to an LLM and the LLM may transform the plurality of historical document section tokens into a plurality of historical document section embeddings. The LLM may output the plurality of historical document section embeddings to the analysis circuitry 208. The historical document section embeddings may be a vector or numerical representation of the historical document section tokens.

In some embodiments, an embedding representation of the historical document section is a matrix. In some embodiments, each row in the matrix includes a historical document section embedding for the historical document section. In some embodiments, each historical document section embedding is a vector embedding of at least a portion of content corresponding to a particular historical document section. Thus, in some embodiments, the embedding representation of a historical document section may be a matrix of dimensions V×d, where V is the of selected historical document section tokens from a given historical document section and d is the embedding dimension.

In some embodiments, the analysis circuitry 208 if the LLM uses the LLM to generate the historical document section embeddings, the analysis circuitry 208 may select a LLM based on an associated modality type associated with the historical document section tokens. In some embodiments, an associated memory, such as memory 204, may store multiple LLMs that may be used to generate the plurality of historical document section embeddings. In some embodiments, the analysis circuitry 208 may be configured to select a specific LLM for historical document section tokens corresponding to a particular modality type. For example, one LLM may be designated (e.g., labelled, tagged, or otherwise indicated) for processing text modality types, another LLM may be designated for processing tabular data modality types, another LLM may be designated for processing image modality types, another LLM may be designated for processing audio modality types, and another LLM may be designated for processing video modality types. Additionally, or alternatively, an LLM may be configured to handle two or more modality types. The analysis circuitry 208 may be configured with rules to select a particular LLM for processing a plurality of historical document section tokens of a particular modality type.

Operations 2502 and 2504 may be repeated for each historical document section in the plurality of historical document sections. Thus, the analysis circuitry 208 may generate an embedding representation for each historical document section.

Returning now to FIG. 23, as shown by operation 2308, the apparatus 200 includes means, such as memory 204, communications hardware 206, analysis circuitry 208 or the like for storing the embedding representations for each historical document section. Once the analysis circuitry 208 has generated the plurality of historical document section embeddings for each historical document section, the analysis circuitry 208 may store the plurality of historical document sections embeddings. In some embodiments, the analysis circuitry 208 may utilize communications hardware 206 to store the plurality historical document section embeddings in an associated historical document repository (e.g., any one of historical document repositories 110A-110N). These historical document section embeddings may then be accessed for subsequent operations, such as for handling a received query as further described in FIG. 27.

In some embodiments, as described above, a particular historical document may correspond to a particular historical document type, such as an MVD or MDD. In some embodiments, different historical document repositories may be designated to store historical documents and/or historical document section embeddings of a certain historical document type. For example, document evaluation repository 110A may store historical documents and/or historical document section embeddings that correspond to MVDs and document evaluation repository 110N may store historical documents and/or historical document section embeddings that corresponds to MDDs. In some embodiments, the analysis circuitry 208 may select a historical document repository for storage that corresponds to the historical document type of the received historical document.

By doing so, the apparatus 200 transforms high-dimensional data (e.g., the content within the historical document) into lower-dimensional vectors, thereby reducing the storage requirements while still preserving the content's semantic meaning. These compact embedding representations of historical document sections further enable the use of real-time content retrieval for queries by using similarity-based searching techniques.

### Example Operations for Efficiently Handling Queries

Turning now to FIG. 27, example operations are shown for handling a received query. Example embodiments described herein provide real-time query responses to queries received from a user. A user may submit a query related to content within historical documents. Example embodiments may include generating an embedding representation of the query and comparing the embedding representation of the query with embedding representations of historical document sections to select a relevant document section embedding for the query. Example embodiments may retrieve the relevant document section embedding and query the LLM using the embedding representation of the prompt and the relevant document section embedding. The LLM may in turn, output a direct response to the query. A query response may be generated to include the direct response to the query as well as links to the corresponding relevant historical document sections. This ensures users receive accurate, contextually relevant answers in real-time.

To provide the query response, example embodiments described herein may tokenize the query into a plurality of query tokens and generate an embedding representation of the query. Example embodiments perform a similarity comparison to determine a similarity between the embedding representation of the query and a set of embedding representations of historical document sections. A relevant historical document section embedding may be selected based on the similarity comparison and the relevant historical document section embedding may be retrieved from a historical document repository. Example embodiments may then query the LLM using the embedding representation of the query and the relevant document section embedding. In some embodiments, the query response includes a generated answer that is responsive to the question posed in the query. The query response may further include links to sources of the relevant historical document sections. In this way, a user is provided with a tailored answer to their query along with the sources of information identified as relevant for the query in real-time.

In some embodiments, a query received from a user may request that an input document be evaluated. By way of particular example, the input document may be a draft MDD or draft MVD. The user may wish to ensure the current input document complies with various policies, standards, regulations, etc. and flag any potential compliance or consistency issues in real-time. Here, example embodiments may query the LLM using the embedding representation for each target document section and the relevant document section embedding. In some embodiments, the LLM may generate and output an evaluation assessment. The evaluation assessment may include an evaluation status for each target document section. In some embodiments, an evaluation status may be indicative of whether a target document section is fully compliant, partially compliant, or non-compliant. If a target document section is partially compliant or non-compliant, the LLM may provide the reasons for an issue, such as identifying missing details or information, incorrect data, and/or the like. The LLM may further provide a recommendation to address the compliance issue and bring the target document section to full compliance. The compliance status, identified compliance issues, and recommendations may be included in the query response. In this way, user may proactively address compliance issues in real-time. Users may further be presented with suggestions on how to address the compliance issues along with the relevant historical document sections, thus saving valuable time.

As shown by operation 2702, the apparatus 200 includes means, such as communications hardware 206 or the like, for receiving a query. The communications hardware 206 may receive a query from a user device (e.g., any one of user devices 106A-106N). The query may also pertain to a particular historical document database, such as any one of historical document repositories 110A-110N. In some embodiments, the query may correspond to an input received from the user. In some embodiments, a user may use the user device to interact with an application selection interface and select a database query application from a software application, such as Microsoft Word, or browser extension. In some embodiments, the software application and/or browser may include a plug-in that allows the user to perform a query and enter a prompt for the query.

In some embodiments, the query may ask a compliance, regulatory, or standards related question, which pertains to one or more historical documents. For example, a query may be “is model X dependent on other models?”. The interdependency of model X on other models may be described within one or more historical documents, such as one or more MDDs.

As shown by operation 2704, the apparatus 200 includes means, such as analysis circuitry 208 or the like for tokenizing the query into a plurality of query tokens. In some embodiments, the analysis circuitry 208 may use any suitable tokenization method to tokenize the query into a plurality of query tokens. In some embodiments, the query is formatted as text and the analysis circuitry 208 may use sub-word tokenization approaches, such as vocabulary mapping, contextual tokenization, and/or the like to tokenize the query. As another example, the query may include an image, table, audio file, video file, etc. and the analysis circuitry 208 may use content tokenization, structural tokenization, pixel-level tokenization, patch-level tokenization, semantic tokenization, and/or the like to tokenize the query. In some embodiments, the analysis circuitry 208 may tokenize the query into a plurality of query tokens in a substantially similar manner as described in operation 2502 of FIG. 25.

In some embodiments, the analysis circuitry 208 may further filter out query tokens that correspond to stop words (i.e., commonly used words that carry little meaningful information), such as “the,” “is,” “and,” etc. This reduces the overall number of query tokens, thereby reducing the overall number of query embeddings.

As shown by operation 2706, the apparatus 200 includes means, such as analysis circuitry 208 or the like for generating an embedding representation of the query. Once the analysis circuitry 208 has tokenized the query into a plurality of query tokens, the analysis circuitry 208 may transform the plurality of query tokens into a plurality of query embeddings, using any suitable technique. For example, in some embodiments, the analysis circuitry 208 may use Word2Vec, GloVe, FastText, associated embedding models (e.g., BERT), and/or the like. Alternatively, in some embodiments, the analysis circuitry 208 may provide the plurality of query tokens to an LLM and the LLM may transform the plurality of query tokens to generate the plurality of query embeddings. In some embodiments, the analysis circuitry 208 may generate the plurality of query embeddings in a substantially similar manner as described in operation 2504 of FIG. 25.

In some embodiments, an embedding representation of the query is a matrix. In some embodiments, each row in the matrix includes a query embedding of the query. In some embodiments, each query embedding is a vector embedding of at least a portion of the query. Thus, in some embodiments, the embedding representation of a query may be a matrix of dimensions V×d, where V is the of selected query tokens and d is the embedding dimension.

As shown by operation 2708, the apparatus 200 includes means, such as analysis circuitry 208 or the like for performing a similarity comparison. In some embodiments, the analysis circuitry 208 may use the embedding representation of the query to select one or more relevant document section embeddings for the query. In some embodiments, the analysis circuitry 208 may determine a similarity score between the embedding representation of the query and a set of embedding representations of historical document sections stored in the historical document repository (e.g., any one of historical document repositories 110A-110N). For example, the analysis circuitry 208 determine the similarity score using a cosine similarity algorithm, a Euclidean distance algorithm, a Manhattan distance algorithm, a Jaccard similarity algorithm, a Pearson Correlation coefficient algorithm, a Hamming distance algorithm, a Mahalanobis Distance algorithm, a Bray-Curtis similar algorithm, a Kullback-Liebler Divergence algorithm, and/or the like. The similarity score may be indicative of a quantitative measure of how closely related or similar a query prompt is to a given historical document section.

In some embodiments, the analysis circuitry 208 may determine a set of embedding representations of historical document sections by selecting one or more embedding representations of historical document sections from an associated historical document repository (e.g., any one of historical document repositories 110A-110N). In some embodiments, an embedding representation of a historical document section may be associated with labels, tags, annotations, flags, or the like. In some embodiments, the analysis circuitry 208 may select only embedding representations of historical document sections that are associated with a term corresponding to a query embedding. For example, a query embedding may be representative of the term “model X.” Thus, the analysis circuitry 208 may only select embedding representations of historical document sections that are associated with a label, tag, annotation, flag, etc. indicative of “model X.” In this way, the analysis circuitry 208 may filter irrelevant embedding representations of historical document sections that are not relevant before performing a similarity comparison. Alternatively, the analysis circuitry 208 may perform a similarity comparison between the embedding representation of the query prompt and each embedding representation of historical document sections stored in a given historical document repository (e.g., any one of historical document repositories 110A-110N).

It will be appreciated that each embedding representation of a historical document section satisfies a token limit for a target LLM. As discussed in FIGS. 23-26, the analysis circuitry 208 may intelligently partition a historical document section such that the number of historical document section tokens for the historical document section would not exceed a maximum token limit of a target LLM (e.g., an LLM designated to be queried in operation 2712). Furthermore, it will be appreciated that each embedding representation of a historical document section represents components of a single historical document section within a historical document.

As shown by operation 2710, the apparatus 200 includes means, such as analysis circuitry 208 or the like for selecting a relevant embedding representation of a historical document section. Once the analysis circuitry 208 has performed a similarity comparison and determined similarity scores for the embedding representations of historical document sections, the analysis circuitry 208 may further select one or more relevant embedding representations of document section embeddings. In some embodiments, the analysis circuitry 208 may determine whether an embedding representation of a historical document section is relevant based on whether an associated similarity score satisfies a similarity score threshold. Additionally, or alternatively, the analysis circuitry 208 may select a predefined number n of embedding representations of historical document sections (e.g., the top ten embedding representations of historical document sections) as the one or more relevant embedding representations of historical document sections.

As shown by operation 2712, the apparatus 200 includes means, such as communications hardware 206, analysis circuitry 208 or the like for querying the LLM using the embedding representation of the query and the relevant embedding representation of the historical document section. In some embodiments, the analysis circuitry 208 may use the communications hardware 206 to retrieve the selected relevant embedding representations of historical document sections from a storage location, such as from a historical document repository (e.g., any one of historical document repositories 110A-110N). Advantageously, by only retrieving relevant historical document section embeddings, this ensures that only relevant historical document sections that correspond to the query are processed. This targeted approach optimizes computational resource usage by minimizing unnecessary processing of irrelevant historical document sections and also reduces the time required to generate a response.

The analysis circuitry 208 may then query the LLM using the embedding representation of the query prompt and the relevant embedding representation of the historical document section. In some embodiments, the analysis circuitry 208 may use the communications hardware 206 to provide the embedding representation of the query prompt and the relevant embedding representation of the historical document section to the LLM, such as when the LLM is hosted, executed, operated, etc. by a computing device other than apparatus 200.

Upon receiving the embedding representation of the query prompt and the relevant embedding representation of the historical document section, the LLM may generate and output a direct response to a question posed in the query. In some embodiments, the LLM may feed the query embeddings of the embedding representation of the query into its associated multiple transformer layers of attention mechanisms and feed-forward neural networks. For each transformer layer, a query embedding may be transformed based on the other query embeddings. This may cause the LLM to temporarily adjust its internal state for the duration of processing the query. In some embodiments, the adjustment of the internal state activates certain neurons that are dynamically changed as the LLM processes the query embeddings. This may allow the LLM to understand the query.

The LLM may also process the plurality of relevant historical document section embeddings of the relevant embedding representation of the historical document section to generate the direct response. In some embodiments, the LLM may be configured to process the historical document section embeddings of the embedding representation of the relevant historical document section after the query embeddings. The LLM may analyze the historical document section embeddings using the adjusted internal state such that the historical document section embeddings are analyzed in the context of the query. The LLM may then be configured to generate a direct response to the query. In some embodiments, the direct response reply may reference the content of historical documents that correspond to relevant historical document section embeddings and/or provide a summary of the relevant content. The LLM may provide the direct response to the analysis circuitry 208. In some embodiments, the analysis circuitry 208 may receive the direct response from the communications hardware 206.

By way of continuing example, the LLM may generate a direct response of “Based on the context from file 12345, section 3.5, it appears model X does not depend on other models . . . ” Thus, the direct response provides an answer to the query “is model X dependent on other models.” Further, the direct response references the rationale behind the answer (e.g., file 12345, section 3.5). The direct response may further provide a summary of the information found in the relevant historical documents, historical document sections, and/or historical document subsections.

In some embodiments, the analysis circuitry 208 may select a target LLM based on an associated modality type associated with the relevant embedding representation of the historical document section. In some embodiments, an associated memory, such as memory 204, may store multiple LLMs that may be provide a direct response and/or evaluation assessment as discussed in FIG. 28. In some embodiments, the analysis circuitry 208 may be configured to select a target LLM to query based on a particular modality type corresponding to the relevant embedding representation of the historical document section. For example, one LLM may be designated (e.g., labelled, tagged, or otherwise indicated) for processing text modality types, another LLM may be designated for processing tabular data modality types, another LLM may be designated for processing image modality types, another LLM may be designated for processing audio modality types, and another LLM may be designated for processing video modality types. Additionally, or alternatively, an LLM may be configured to handle two or more modality types. The analysis circuitry 208 may be configured with rules to select a particular LLM for querying. In some embodiments, the analysis circuitry 208 may query more than one LLM.

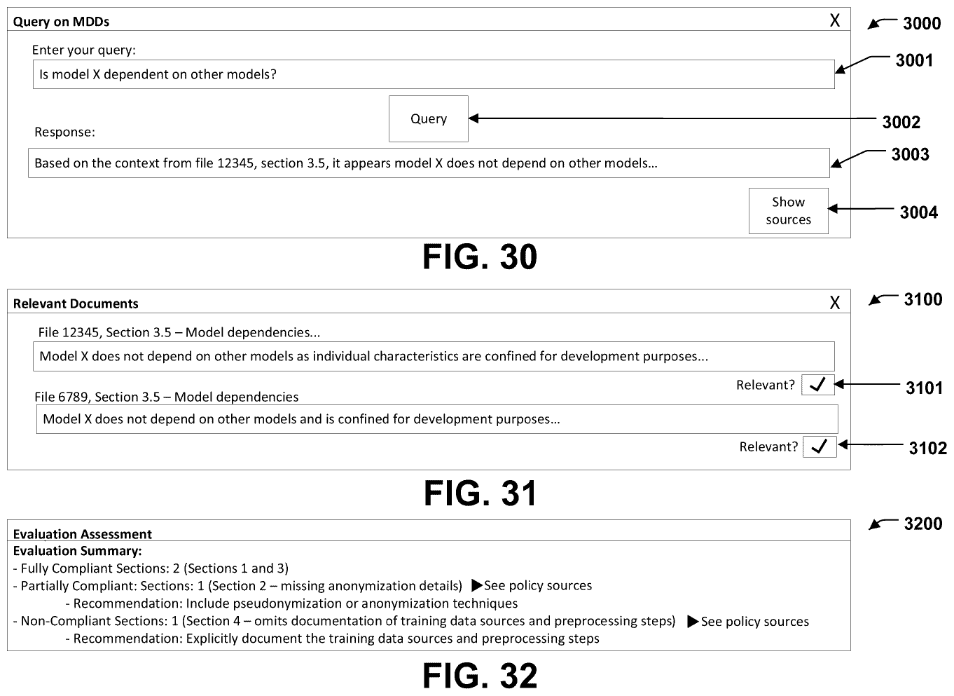

As shown by operation 2714, the apparatus 200 includes means, such as communications hardware 206, analysis circuitry 208, or the like for providing a query response. The analysis circuitry 208 may use the communications hardware 206 to provide the query response to a user, such as via a user device (e.g., any one of user devices 106A-106N). In some embodiments, the user may use an output user interface of a query plug-in to download, view, or otherwise access the query response. An example query user interface is illustrated in FIGS. 30-31.

Once the analysis circuitry 208 receives the direct response, the analysis circuitry 208 may generate the query response. The query response may include the direct response. In some embodiments, the query response may further include a reference, link, or other indication of the content of the historical document associated with the plurality of relevant historical document section embeddings. In particular, the analysis circuitry 208 may use a section identifier or other metadata stored alongside the relevant embedding representation of the historical document section to identify the original corresponding content from a corresponding historical document. In some embodiments, the original historical document may also be stored in the historical document repository and the analysis circuitry 208 may retrieve the corresponding content using communications hardware 206. Alternatively, the original historical documentation may be stored elsewhere, such as in a different repository or in memory 204. The analysis circuitry 208 may then retrieve the corresponding content from the associated storage location. The analysis circuitry 208 may generate the query response to directly include the content and/or include a link to the content.

In some embodiments, the user may also use a user feedback mechanism user interface of query plug-in to provide feedback on the quality of the query response and/or the content identified as relevant. This feedback may be used to further fine-tune the LLM.

Turning now to FIG. 28, example operations are shown for handling a query that requests evaluation of an input document. In some embodiments, when a query requests evaluation of an input document, the operations described in FIG. 28 may be performed in addition to the operations described in FIG. 27.

As shown by operation 2802, the apparatus 200 includes means, such as analysis circuitry 208 or the like for determining that the query requests evaluation of an input document. In some embodiments, a query received from a user device (e.g., any one of user devices 106A-106N) may request that an associated input document be validated for compliance. By way of particular example, a user may currently have a Microsoft Word document open and may access a query plug-in to enter a query. The query may be indicative of a request to confirm whether the current document complies with various requirements as defined by one or more historical documents. For example, a query may be “Does this document comply with the requirements of the model risk management policy?”

In some embodiments, the analysis circuitry 208 may determine the query requests evaluation of an input document during operation 2706. That is, after the analysis circuitry 208 has generated the embedding representation of the query, the analysis circuitry 208 may determine the embedding representation of the query is indicative of a request for an input document to be evaluated. Alternatively, the analysis circuitry 208 may determine the query requests an evaluation of an input document during operation 2714. Alternatively, the analysis circuitry 208 may determine the query requests evaluation of an input document in a separate operation not described in FIG. 27

An input document may be a document a user may provide and desire to be evaluated to ensure compliance. The input document may be a document formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), and/or the like.

As shown by operation 2804, the apparatus 200 includes means, such as analysis circuitry 208 or the like for partitioning the input document into one or more target document sections. In some embodiments, the analysis circuitry 208 may be used to partition the input document into one or more target document sections. In some embodiments, the analysis circuitry 208 may use the compliance requirement document to determine the one or more target document sections. This process may be substantially similar to the processes described in operation 306 of FIG. 3 and/or operation 2304 of FIG. 23.

In some embodiments, operations 2804 may be performed in accordance with the operations described by FIG. 29. Turning now to FIG. 29, example operations are shown for tokenizing a target document section.

As shown by operation 2902, the apparatus 200 includes means, such as analysis circuitry 208 or the like for detecting a first modality type for content within a target document section. The analysis circuitry 208 may use a classification model to process the content from a given target document section and detect a first modality type for content within the target document section. This process may be substantially similar to the process described in operation 2402 of FIG. 24.

As shown by operation 2904, the apparatus 200 includes means, such as analysis circuitry 208 or the like for detecting a second modality type for content within the target document section. The classification model may detect content within the target document of a second modality type that is different than the first modality type. This process may be substantially similar to the process described in operation 2404 of FIG. 24.

As shown by operation 2906, the apparatus 200 includes means, such as analysis circuitry 208 or the like for partitioning the target document section into a plurality of target document subsections based on a corresponding modality type. The analysis circuitry 208 may be configured to partition the target document section into a plurality of target document subsections based on the corresponding modality type. This process may be substantially similar to the process described in operation 2406 of FIG. 24.

Returning now to FIG. 28, as shown by operation 2806, the apparatus 200 includes means, such as analysis circuitry 208 or the like for tokenizing the one or more target document sections into a plurality of target document section tokens. The analysis circuitry 208 may tokenize the content of each target document section to generate a plurality of target document section tokens. The analysis circuitry 208 may use any suitable tokenization method to tokenize the target document section. In some embodiments, the analysis circuitry 208 may use sub-word tokenization approaches, vocabulary mapping, contextual tokenization, and/or the like. In some embodiments, the analysis circuitry 208 may further filter out target document section tokens that correspond to stop words (i.e., commonly used words that carry little meaningful information), such as “the,” “is,” “and,” etc. This reduces the overall number of target document section tokens, thereby reducing the overall number of target document section embeddings. This process may be substantially similar to the process described in operation 2502 of FIG. 25 and operations 2602-2606 of FIG. 26.

As shown by operation 2808, the apparatus 200 includes means, such as analysis circuitry 208 or the like for generating an embedding representation of each target document section. In some embodiments, the analysis circuitry 208 may generate a plurality of target document section embeddings from the plurality of target document section tokens using any suitable technique. For example, in some embodiments, the analysis circuitry 208 may use Word2Vec, GloVe, FastText, associated embedding models (e.g., BERT), and/or the like. Alternatively, in some embodiments, the analysis circuitry 208 may provide the plurality of target document section tokens to an LLM and the LLM may transform the plurality of target document section tokens into a plurality of target document section embeddings. The LLM may output the plurality of target document section embeddings to the analysis circuitry 208. The target document section embeddings may be a vector or numerical representation of the target document section tokens. This process may be substantially similar to the process described in operation 2504 of FIG. 25.

As shown by operation 2810, the apparatus 200 includes means, such as analysis circuitry 208 or the like for querying a large language model using the embedding representation of each target document section and the relevant embedding representation of the historical document section. In some embodiments, the analysis circuitry 208 may query the LLM using the embedding representations of each target document section and the relevant embedding representation of the historical document section. In some embodiments, the analysis circuitry 208 may use the communications hardware 206 to provide the embedding representations of each target document section and the relevant embedding representation of the historical document section to the LLM, such as when the LLM is hosted, executed, operated, etc. by a computing device other than apparatus 200.

Upon receiving the embedding representations, the LLM may generate and output an evaluation assessment. An evaluation assessment may be a summary of an evaluation status for each target document section. In some embodiments, the evaluation status may indicate whether the target document section is fully compliant, partially compliant, or non-compliant. If a target document section is partially compliant or non-compliant, the LLM may provide the reasons for a compliance issue, such as identifying missing details or information, incorrect data, and/or the like. In some embodiments, compliant target document section may refer to a target document section that includes similar formatting as historical documents, incorporates similar levels of detail as historical documents, includes information consistent with information within historical documents, and/or the like.

The LLM may perform a similarity comparison for the plurality of relevant historical document section embeddings of the embedding representation and the plurality of target document section embeddings of the embedding representations for each target document section. For example, the LLM may determine a similarity score between the embeddings using a cosine similarity algorithm, a Euclidean distance algorithm, a Manhattan distance algorithm, a Jaccard similarity algorithm, a Pearson Correlation coefficient algorithm, a Hamming distance algorithm, a Mahalanobis Distance algorithm, a Bray-Curtis similar algorithm, a Kullback-Liebler Divergence algorithm, and/or the like. Here, a high similarity score between historical document section embeddings and target document section embeddings may be indicative that the content of the target document aligns well with the historical document and is therefore compliant. A low similarity score may suggest non-compliance and a neutral (e.g., middle-ground value) may suggest partial compliance. Thus, the LLM may determine an evaluation status for a target document section based on the associated similarity score.

In some embodiments, the evaluation assessment may also include a reason for the evaluation status. A reason may be provided in natural language and serve as an interpretation for the evaluation status. By way of particular example, the LLM may determine an evaluation status of “partially compliant” for target document section 2 and may generate a reason of “missing anonymization details required by file 4567, section 3.2).” As another example, the LLM may determine an evaluation status of “non-compliant” for target document section 4 and may generate a reason of “omits documentation of training data sources and preprocessing steps as required by file 4567, section 4.5).” Thus, the user may be made aware of the reason for the evaluation status of a given target document section. In some embodiments, the LLM may use attention mechanisms to identify the most relevant portions of the target document section embeddings and may weight these target document section embeddings more heavily when generating the reason.

Furthermore, in some embodiments, the evaluation assessment may include a recommendation to address the compliance issue and bring the target document section into compliance. By way of continuing example, the LLM may generate a recommendation to “include pseudoanonymization or anonymization techniques” for the partially compliant target document section 2. The LLM may further generate a recommendation to “explicitly document the training data sources and preprocessing steps” for the noncompliant target document section 4. Thus, the user may also gain insight into how to rectify compliance related issues for a given target document section. In some embodiments, the LLM may use attention mechanisms to identify the most relevant portions of the historical document embeddings and may weight these historical document section embeddings more heavily when generating the recommendation.

The LLM may output the evaluation assessment to the analysis circuitry 208. In some embodiments, the analysis circuitry 208 may receive the evaluation assessment from the communications hardware 206. The analysis circuitry 208 may include the evaluation assessment in the query response. Thus, the user may view the evaluation of the input document.

Optionally, as shown by operation 2812, the apparatus 200 includes means, such as automation circuitry 212 or the like for performing a compliance action based on the evaluation assessment. In some embodiments, if the evaluation assessment is indicative of any target document sections with a partial-compliance or non-compliant status, the automation circuitry 212 may be configured to perform one or more proactive compliance actions. A proactive compliance action may be an operation or series of operations that are performed automatically by the automation circuitry 212 to bring a target document section into compliance. In some embodiments, the automation circuitry 212 may automatically modify or insert compliance-related language within a target document section to rectify a compliance issue. The automation circuitry 212 may indicate the added language, such as by using highlighting, font color, underlining, font style, or other indicators to show the modified or added language. Thus, the automation circuitry 212 may automatically perform proactive actions to bring a target document section into compliance without requiring manual intervention. In some embodiments, the automation circuitry 212 may cause the operations 2804-2810 to be performed on the updated input document to ensure the target document sections are fully compliant. This process may repeat until the evaluation assessment is indicative that all target document sections are associated with a fully compliant, compliance status. Thus, example embodiments allow for automatic management of input documents to ensure compliance. This may streamline workflows and enable deployment or use of the verified compliant input document in real-time. Example embodiments thus automatically and proactively identify and correct input document compliance issues, thereby preventing costly errors and conserving computational resources that would otherwise be devoted to identifying noncompliance before deployment and/or revising the document after deployment. The real-time evaluation and validation of input documents is particularly important in industries with strict compliance standards, such as finance, legal, and healthcare, which may be subject to audits or other compliance checks.

Once the apparatus 200 has generated the evaluation assessment and/or performed the proactive compliance action, the apparatus 200 may proceed back to operation 2714, where the apparatus 200 may generate the query response. The query response may further include the evaluation assessment. In some embodiments, the proactive compliance action may be performed before, after, or simultaneously with the generation and/or provision of the query response.

### Example Operations for Fine-Tuning the Large Language Model

Turning now to FIG. 14, example operations are shown for fine-tuning a LLM by performing a training routine. Example embodiments train an LLM for one or more validation applications, including an internal chat application, a document compliance check application, a document chat application, a data summary application, a document summary application, a document change detection application, a new document generation application, a query application, and/or the like.

The LLMs may be trained to evaluate input in accordance with the particular institution rules and standards. Thus, the LLMs may perform these validation operations in a manner that is tailored to the specific needs of the institution. In particular, the LLMs may be trained using a training routine. The training routine may initialize a base LLM to start and use transfer learning to fine-tune an LLM. By leveraging transfer learning, the training process required to train the LLM may be shortened and result in a more effective and accurate model. The LLM may then be fine-tuned using a domain-specific training data set. This domain-specific training data set may be curated to include domain-specific documents, domain-specific media, and/or domain-specific data such that the LLM may be fine-tuned to capture the institutions requirements.

As shown by operation 1402, the apparatus 200 includes means, such as training circuitry 210 or the like for initializing a base LLM. In some embodiments, the training circuitry 210 may be configured to select and initialize a base LLM to be modified. The base LLM may be trained for certain parameters but may currently lack specificity for the particular domain of interest.

As shown by operation 1404, the apparatus 200 includes means, such as training circuitry 210 or the like for fine-tuning the base LLM. In particular, the training circuitry 210 may use a domain-specific training data set to fine-tune or adjust parameters of the base LLM. The training circuitry 210 may provide domain-specific training data included in the domain-specific training data set to the base LLM. By processing the domain-specific training data set, the parameters of the base LLM may be adjusted based on the domain-specific training data included in the domain-specific training data set.

The domain-specific training data may capture the rules, criteria, formatting, guidelines, etc. of the institution. As an illustrative example, the abbreviation “RAM” may stand for random access memory when used in the computer science domain but may stand for remote area medical when used in the context of healthcare technology. These types of domain-specific contexts may be captured in the domain-specific training data such that the resulting LLM may be configured to process, analyze, and generate data within the particular domain of interest.

Once the base LLM had been adjusted, the resulting model with the updated parameters may be used as the LLM. In some embodiments, the training circuitry 210 may fine-tune the LLM based on the base LLM and the adjusted parameters. In some embodiments, the training circuitry 210 may apply transfer learning techniques to fine-tune the base LLM and fine-tune the LLM that is tailored to the specific domain of interest.

Optionally, as shown by operation 1406, the apparatus 200 includes means, such as training circuitry 210 or the like for generating an approved query prompt list. In some embodiments, during the training routine, the training circuitry 210 may identify query prompts that were provided to the base LLM within the domain-specific training data set. These query prompt may be included as approved query prompts within the query prompt list. In some embodiments, the training circuitry 210 may further test a candidate query prompt after the LLM is fine-tuned during a verification and/or validation training period. In an instance that the LLM generates a suitable response to the candidate query prompt, the candidate query prompt may be included in the approved query prompt list. In some embodiments, an end user may be used to determine whether the LLM generates a suitable response. Alternatively, the training circuitry 210 may be configured to automatically determine whether the generated response is suitable. As such, the training circuitry 210 may be configured to generate and maintain a curated list of approved query prompts. This may help ensure the LLM outputs quality and accurate responses in response to received queries. The training circuitry 210 may store the approved query prompt list in an associated memory, such as memory 204.

Optionally, as shown by operation 1408, the apparatus 200 includes means, such as memory 204, communications hardware 206 or the like for receiving user feedback. As described above, in some embodiments, the communications hardware 206 may receive user feedback in response to a provided output. This feedback may be indicative of the quality and/or accuracy of the provided output for the particular application. The communications hardware 206 may be configured to store received user feedback in an associated memory, such as memory 204. The received user feedback may be used to retrain and/or fine-tune the LLM.

Optionally, as shown by operation 1410, the apparatus 200 includes means, such as training circuitry 210 or the like for updating the LLM based on the received user feedback. In particular, the training circuitry 210 may be configured to provide the LLM with the received user feedback such that the LLM may process the user feedback and further refine its parameters.

Turning now to FIG. 15, example operations are shown for generating a domain-specific training data set that may be used to train the LLM.

As shown by operation 1502, the apparatus 200 includes means, such as communications hardware 206 or the like for receiving annotated authentic domain-specific documents. In some embodiments, the communications hardware 206 may be configured to receive annotated authentic domain-specific documents. In some embodiments, the received annotated authentic domain-specific documents may be annotated by a subject matter expert. An annotated authentic domain-specific document may include an authentic domain-specific document formatted in any suitable format, such as a text document (e.g., word processor document (such as files with DOC or DOCX extensions), portable document format (such as files with a PDF extension), HyperText Markup Language (such files with as HTML or HTM extensions), a spreadsheet (such as files with XLS or XLSX extensions), and/or the like. In some embodiments, the annotated authentic domain-specific documents may include an indication of one or more target document sections. In some embodiments, the annotated authentic domain-specific documents may further include a training query prompt and an expected response to the training query prompt.

As shown by operation 1504, the apparatus 200 includes means, such as communications hardware 206 or the like for receiving annotated authentic domain-specific media. In some embodiments, the received annotated authentic domain-specific media may be annotated by a subject matter expert. Annotated authentic domain-specific media may include an authentic domain-specific media formatted in any suitable format, such as a picture, audio file, video file, and/or the like. In some embodiments, the annotated authentic domain-specific media may further include a training query prompt and an expected response to the training query prompt.

As shown by operation 1506, the apparatus 200 includes means, such as communications hardware 206 or the like for receiving annotated authentic domain-specific data. In some embodiments, the communications hardware 206 may be configured to receive annotated authentic domain-specific data. In some embodiments, the communications hardware 206 may be configured to receive annotated authentic domain-specific data. In some embodiments, the received annotated authentic domain-specific data may be annotated by a subject matter expert. Annotated authentic domain-specific data may include an authentic domain-specific document formatted in any suitable format, such as a structured text document (e.g., word processor document (such as files with DOC or DOCX extensions), structured portable document format (such as files with a PDF extension), HyperText Markup Language (such files with as HTML or HTM extensions), a structured spreadsheet (such as files with XLS or XLSX extensions), and/or the like. In some embodiments, the annotated authentic domain-specific data may include an indication of one or more data values and one or more data fields. In some embodiments, the annotated authentic domain-specific data may further include a training query prompt and an expected response to the training query prompt.

As shown by operation 1508, the apparatus 200 includes means, such as processor 202, memory 204, training circuitry 210, or the like, for generating a domain-specific training data set based on the annotated authentic domain-specific documents, annotated authentic domain-specific media, and/or annotated authentic domain-specific data. The training circuitry 210 may use the received domain-specific training data set based on the annotated authentic domain-specific documents, annotated authentic domain-specific media, and/or annotated authentic domain-specific data to generate the domain-specific training data set. The training circuitry 210 may store and maintain the domain-specific training data set within an associated memory, such as memory 204.

FIGS. 3-15 and 23-29 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### Example User Interface

Turning to FIGS. 16-22 and 30-32, various graphical user interfaces (GUIs) are provided that illustrates example user interfaces. As noted previously, a user may interact with the validation system 102 by directly engaging with communications hardware 206 of an apparatus 200 of the validation system 102. In such an embodiment, the GUIs shown in FIG. 16-22 may be displayed to a user by the apparatus 200. Alternatively, a user may interact with the validation system 102 using a separate user device (e.g., any of user device 106A-106N, as shown in FIG. 1), which may communicate with the validation system 102 via communications network 104. In such an embodiment, the GUIs shown in FIGS. 16-22 may be displayed to the user by the user device.

As shown by FIG. 16, an example application selection user interface 1600 may display various available application available to a user. For example, the user may interact with a first application interaction element 1601 to access an internal chat application. As another example, the user may interact with a second application interaction element 1602 to access a document compliance check application. As another example, the user may interact with a third application interaction element 1603 to access a document chat application. As another example, the user may interact with a fourth application interaction element 1604 to access a data summary application. As another example, the user may interact with a fifth application interaction element 1605 to access a document summary application. As another example, the user may interact with a sixth application interaction element 1606 to access a document change detection application. As another example, the user may interact with a seventh application interaction element 1607 to access a new document generation application.

Turning now to FIG. 17, an example input user interface 1700 of the document compliance check application is depicted. The input user interface 1700 may allow a user to upload an input document using interaction element 1701. The input user interface 1700 may also allow a user to upload a compliance requirement document file using interaction element 1702. The user may further interact with interaction element 1703 to submit the uploaded input document and compliance requirement document to apparatus 200. The communications hardware 206 may receive the submitted input document and compliance requirement document and provide the documents to analysis circuitry 208. In turn, this may cause the analysis circuitry to perform the operations described in FIG. 3.

Turning now to FIG. 18, an example compliance checklist 1800 is depicted. The example compliance checklist 1800 may include a plurality of queries 1801 that may each be associated with a query prompt 1803. Each query prompt 1803 may further correspond to a target document section 1802. The compliance checklist 1800 may further indicate a binary response 1804 to the query prompt and further, may include a reason 1805 for the response. Thus, the compliance checklist 1800 may provide a user with an overview of the compliance of a given input document.

Turning now to FIG. 19, an example user feedback mechanism user interface 1900 is depicted. The user feedback mechanism user interface 1900 may depict a user feedback document that includes a plurality of user feedback questions along with predefined user response options. The user feedback mechanism user interface 1900 may further allow a user to provide freeform feedback for one or more user feedback questions. The user feedback mechanism user interface 1900 may solicit user feedback for each query prompt in the compliance checklist. A user may use interaction element 1902 to move to the next query feedback section of the user feedback document. Once a user has finished filling out all or a portion of the user feedback document, the user may use interaction element 1901 to submit the user feedback document. The communications hardware 206 may receive the submitted user feedback document and store the user feedback document in an associated memory, such as document evaluation repository 112. In some embodiments, the user feedback document may be used to fine-turn the LLM, as described in FIG. 14.

Turning now to FIG. 20, an example user interface 2000 of an internal chat application is depicted. As shown in FIG. 20, the user may enter both a query context 2001 (e.g., “paraphrase this conclude of a financial model review”) and a main query 2002 (e.g., no target scope validation . . . ) into an input box 2003. The user may submit the input, which includes the query context and main query, using a user interaction element 2004. The communications hardware 206 may receive the user input and pass this to the analysis circuitry 208.

Turning next to FIG. 21, an example output user interface 2100 of the internal chat application to view is depicted. As shown in FIG. 21, the user may be presented with the domain-specific response 2102. The user may also view their entered query 2101. Although not shown, the user interface 2000 may also include an input box that allows a user to provide additional queries and/or query contexts.

Turning next to FIG. 22, an example input user interface 2200 of an internal chat application is depicted. As shown in FIG. 22, the user may enter a query context 2201 (e.g., “summarize the following text in 150 words or less”) separately from a main query. The user may submit the input, which includes the query context using a user interaction element (not shown) alone or with an entered main query. The communications hardware 206 may receive the user input and pass this to the analysis circuitry 208.

Turning next to FIG. 30, an example query user interface 3000 is depicted. As shown in FIG. 32, a user may enter a query into an input box 3001. The user may further interact with user interaction element 3002 to submit the input query. This may cause the communications hardware 206 to receive a query. The query user interface 3000 may further include a response box 3003. The response box 3003 may include the query response to the query. Thus, the user may view the query response generated from the input query. Additionally, the query user interface 3000 may include a user interaction element 3004. If the user interacts with (e.g., clicks, touches, or otherwise selects) this user interaction element 3004, the communications hardware 206 may further provide the historical documents and/or historical document sections determined to be relevant to the query. In some embodiments, the relevant historical documents and/or historical document sections may be shown in a new window or interface, such as the one depicted in FIG. 30.

Turning now to FIG. 31, an example query user interface 3100 is depicted. As shown in FIG. 31, a user may be presented with one or more relevant historical documents and/or historical document sections. The user may review the historical documents and/or historical document sections within the query user interface 3100 or may use the query user interface 3100 to access a historical document from storage. The user may further interact with user interaction element 3101 and/or user interaction element 3101 to provide user feedback indicative of whether the corresponding historical document and/or historical document section is relevant to the provided query.

Finally, FIG. 32 depicts an example query user interface 3200 that includes an evaluation assessment. As shown in FIG. 32, a user may be presented with an overview of the input document sections that are determined to be fully compliant, partially compliant, and non-compliant. The query user interface 3200 may further indicate the reasons for partial compliance and/or non-compliance in the corresponding sections as well as recommendations to address these deficiencies. In some embodiments, the query user interface 3200 may further allow the user to view the historical documents and/or historical document sections used for the evaluation assessment.

### CONCLUSION

As described above, example embodiments provide methods and apparatuses that enable improved domain-specific validation. The validation system may leverage one or more LLMs to automatically perform various validation operations, thereby reducing or eliminating the manual burden on institutions. Furthermore, the LLMs may be trained to evaluate input in accordance with the particular institution rules and standards. Thus, the LLMs may perform these validation operations in a manner that is tailored to the specific needs of the institution. In particular, the LLMs may be trained using a training routine. The training routine may initialize a base LLM to start and use transfer learning to fine-tune an LLM. By leveraging transfer learning, the training process required to train the LLM may be shortened and result in a more effective and accurate model. The LLM may then be fine-tuned using a domain-specific training data set. This domain-specific training data set may be curated to include domain-specific documents, domain-specific media, and/or domain-specific data such that the LLM may be fine-tuned to capture the institutions requirements.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for efficient handling of queries, the method comprising:
receiving, by communications hardware, a query from a user device;
generating, by analysis circuitry, an embedding representation of the query;
performing, by the analysis circuitry, a similarity comparison between the embedding representation of the query and a set of embedding representations of historical document sections stored in a historical document repository, wherein each embedding representation of a historical document section satisfies a token limit for a target large language model and each embedding representation of a historical document section represents components of a single historical document section within a historical document;
selecting, by the analysis circuitry and based on the similarity comparison, a relevant embedding representation of a historical document section stored in the historical document repository for the query;
querying, by the analysis circuitry, the target large language model using the embedding representation of the query and the relevant embedding representation of the historical document section; and
providing, by the communications hardware, a query response to the user device.

2. The method of claim 1, further comprising:
receiving, by the communications hardware, a historical document;
partitioning, by the analysis circuitry, the historical document into one or more historical document sections;
performing, by the analysis circuitry, a document embedding routine for each historical document section of the one or more historical document sections, the document embedding routine comprising:
tokenizing, by the analysis circuitry, a historical document section into a plurality of historical document section tokens, and
generating, by the analysis circuitry and based on the plurality of historical document section tokens, an embedding representation of the historical document section; and
storing, by the analysis circuitry, the embedding representation for each historical document section in the historical document repository.

3. The method of claim 2, further comprising:
determining, by the analysis circuitry, whether a number of historical document section tokens for the historical document section would exceed a maximum token limit; and
in response to determining the maximum token limit would be exceeded, partitioning, by the analysis circuitry, the historical document section into a plurality of historical document subsections, wherein each of the plurality of historical document subsections may be tokenized into a plurality of historical document section tokens.

4. The method of claim 2, further comprising:
detecting, by the analysis circuitry, a first modality type for content within a historical document section;
detecting, by the analysis circuitry, a second modality type for the content within the historical document section, wherein the second modality type is different than the first modality type; and
in response to detecting that the second modality type is different than the first modality type, partitioning, by the analysis circuitry, the historical document section into a plurality of historical document subsections based on a corresponding modality type, wherein each of the plurality of historical document subsections may be tokenized into a plurality of historical document section tokens.

5. The method of claim 1, further comprising:
determining, by the analysis circuitry, whether the query requests an evaluation for an input document;
in response to determining that the query requests the evaluation for the input document, partitioning, by the analysis circuitry, the input document into a plurality of target document sections;
tokenizing, by the analysis circuitry, each target document section into a plurality of target document section tokens;
generating, by the analysis circuitry and based on the plurality of target document section tokens, an embedding representation of each target document section; and
querying, by the analysis circuitry, the target large language model using the embedding representation for each target document section and the relevant embedding representation of the historical document section, wherein the query response further comprises an evaluation assessment and the evaluation assessment comprises an evaluation status for each target document section.

6. The method of claim 5, wherein the evaluation assessment comprises an evaluation reason for the evaluation status.

7. The method of claim 5, wherein evaluation assessment further comprises a recommendation for a target document section.

8. The method of claim 5, further comprising performing, by automation circuitry, a proactive action in an instance in which the evaluation assessment comprises at least one evaluation status indicative that a target document section is non-compliant.

9. The method of claim 8, wherein performing the proactive action further comprises automatically updating, by the automation circuitry, the input document to (i) modify current language or (ii) insert new language.

10. The method of claim 5, further comprising:
detecting, by the analysis circuitry, a first modality type for content within a target document section;
detecting, by the analysis circuitry, a second modality type for the content within the target document section, wherein the second modality type is different than the first modality type; and
in response to detecting that the second modality type is different than the first modality type, partitioning, by the analysis circuitry, the target document section into a plurality of target document subsections based on a corresponding modality type, wherein each of the plurality of target document subsections may be tokenized into a plurality of target document section tokens.

11. The method of claim 5, further comprising:
determining, by the analysis circuitry, whether a number of target document section tokens for a target document section would exceed a maximum token limit; and
in response to determining the maximum token limit would be exceeded, partitioning, by the analysis circuitry, the target document section into a plurality of target document subsections, wherein each of the plurality of target document subsections may be tokenized into a plurality of target document section tokens.

12. The method of claim 1, further comprising:
performing, by training circuitry, a training routine, the training routine comprising:
initializing, by the training circuitry, a base large language model, and
adjusting, by the training circuitry, the base large language model based on a domain-specific training data set.

13. The method of claim 12, further comprising;
receiving, by the communications hardware, annotated authentic domain-specific documents, wherein:
each annotated authentic domain-specific document includes (i) a corresponding authentic domain-specific document, (ii) a training query prompt, (iii) and an expected response to the training query prompt,
the domain-specific training data set comprises the annotated authentic domain-specific documents.

14. The method of claim 1, wherein the historical document is at least one of a model development document and a model validation document.

15. An apparatus for efficient handling of queries, the apparatus comprising:
communications hardware configured to receive a query from a user device; and
analysis circuitry configured to:
generate an embedding representation of the query,
perform a similarity comparison between the embedding representation of the query and a set of embedding representations of historical document sections stored in a historical document repository, wherein each embedding representation of a historical document section satisfies a token limit for a target large language model and each embedding representation of a historical document section represents components of a single historical document section within a historical document,
select, based on the similarity comparison, a relevant embedding representation of a historical document section stored in the historical document repository for the query, and
query the target large language model using the embedding representation of the query and the relevant embedding representation of the historical document section,
wherein the communications hardware is further configured to provide a query response to the user device.

16. The apparatus of claim 15, wherein the communications hardware is further configured to receive a historical document,
wherein the analysis circuitry is further configured to:
partition the historical document into one or more historical document sections;
perform a document embedding routine for each historical document section of the one or more historical document sections, the document embedding routine comprising:
tokenizing a historical document section into a plurality of historical document section tokens, and
generating, based on the plurality of historical document section tokens, an embedding representation of the historical document section; and
store the embedding representation for each historical document section in the historical document repository.

17. The apparatus of claim 16, wherein the analysis circuitry is further configured to:
determine whether a number of historical document section tokens for the historical document section would exceed a maximum token limit; and
in response to determining the maximum token limit would be exceeded, partition the historical document section into a plurality of historical document subsections, wherein each of the plurality of historical document subsections may be tokenized into a plurality of historical document section tokens.

18. The apparatus of claim 16, wherein the analysis circuitry is further configured to:
detect a first modality type for content within a historical document section;
detect a second modality type for the content within the historical document section, wherein the second modality type is different than the first modality type; and
in response to detecting that the second modality type is different than the first modality type, partition the historical document section into a plurality of historical document subsections based on a corresponding modality type, wherein each of the plurality of historical document subsections may be tokenized into a plurality of historical document section tokens.

19. The apparatus of claim 15, wherein the analysis circuitry is further configured to:
determine whether the query requests an evaluation for an input document;
in response to determining that the query requests the evaluation for the input document, partition the input document into a plurality of target document sections;
tokenize each target document section into a plurality of target document section tokens;
generate, based on the plurality of target document section tokens, an embedding representation of each target document section; and
query the target large language model using the embedding representation for each target document section and the relevant embedding representation of the historical document section, wherein the query response further comprises an evaluation assessment and the evaluation assessment comprises an evaluation status for each target document section.

20. A computer program product for efficient handling of queries, the computer program product comprising at least one non-transitory computer-readable storage medium storing software instructions that, when executed, cause an apparatus to:
receive a query from a user device;
generate an embedding representation of the query;
perform a similarity comparison between the embedding representation of the query and a set of embedding representations of historical document sections stored in a historical document repository, wherein each embedding representation of a historical document section satisfies a token limit for a target large language model and each embedding representation of a historical document section represents components of a single historical document section within a historical document;
select, based on the similarity comparison, a relevant embedding representation of a historical document section stored in the historical document repository for the query;
query the target large language model using the embedding representation of the query and the relevant embedding representation of the historical document section; and
provide a query response to the user device.
